(19) United States
(12) Patent Application Publication
(10) Pub. No.: US 2016/0007340 A1
(43) Pub. Date: Jan. 7, 2016

(54) METHOD FOR REPORTING CHANNEL STATE INFORMATION IN WIRELESS COMMUNICATION SYSTEM AND APPARATUS THEREFOR

(71) Applicants: LG ELECTRONICS INC., Yeongdeungpo-gu, Seoul (KR); SOGANG UNIVERSITY RESEARCH FOUNDATION

(72) Inventors: Jonghyun PARK, Seoul (KR); Byounghoon KIM, Seoul (KR); Jihoon SUNG, Seoul (KR); Wonjin SUNG, Seoul (KR); Kijun KIM, Seoul (KR)

(73) Assignees: LG Electronics Inc., Seoul (KR); Sogang University Rsearch Foundation, Seoul (KR)

(21) Appl. No.: 14/769,010

(22) PCT Filed: Mar. 14, 2014
(86) PCT No.: PCT/KR2014/002195

§ 371 Date: Aug. 19, 2015

Related U.S. Application Data
(60) Provisional application No. 61/781,009, filed on Mar. 14, 2013.

(51) Int. Cl. H04W 72/04; H04B 7/04; H04L 5/00

(52) U.S. Cl. CPC H04W 72/0413; H04L 5/0023; H04L 5/0053; H04B 7/0417; H04L 5/0026

(57) ABSTRACT

A method for reporting channel state information (CSI) in a wireless communication system and an apparatus therefor are disclosed. According to an example of the present invention, a method in which a terminal transmits CSI in a wireless communication system may comprise: a step of receiving data about a feedback antenna port configuration from a base station; and a step of transmitting CSI regarding K (K≧1) feedback antenna ports from each of N (N≧2) reporting resources to the base station. The K feedback antenna ports may be a part of M (M≧2) antenna ports. The CSI regarding K feedback antenna ports may include phase information about the K feedback antenna ports. The phase information about the K feedback antenna ports may be determined by assuming a phase difference with respect to a reference antenna port.

### TECHNICAL FIELD

The present invention relates to wireless communication systems, and more particularly, to a method for reporting channel state information in a wireless communication system and an apparatus therefor.

### BACKGROUND ART

As an example of a wireless communication system to which the present invention is applicable, a 3rd Generation Partnership Project Long Term Evolution (3GPP LTE) (hereinafter, referred to as ‘LTE’) communication system is briefly described.

FIG. 1 is a view schematically illustrating the network architecture of an E-UMTS as an exemplary wireless communication system. An Evolved Universal Mobile Telecommunications System (E-UMTS) is an advanced version of a legacy Universal Mobile Telecommunications System (UMTS) and standardization thereof is currently underway in the 3GPP. E-UMTS may be generally referred to as an LTE system. For details of the technical specifications of UMTS and E-UMTS, reference can respectively be made to Release 7 and Release 8 of “3rd Generation Partnership Project; Technical Specification Group Radio Access Network”.

Referring to FIG. 1, the E-UMTS includes a User Equipment (UE), eNode Bs (eNBs), and an Access Gateway (AG) which is located at an end of a network (Evolved-Universal Terrestrial Radio Access Network ((E-UTRAN)) and connected to an external network. The eNBs may simultaneously transmit multiple data streams for a broadcast service, a multicast service, and/or a unicast service.

One or more cells may exist in one eNB. A cell is configured to use one of bandwidths of 1.25, 2.5, 5, 10, 20 MHz to provide a downlink or uplink transport service to several UEs. Different cells may be configured to provide different bandwidths. The eNB controls data transmission and reception for a plurality of UEs. The eNB transmits downlink scheduling information for downlink data to notify a corresponding UE of a data transmission time/frequency domain, coding, data size, and Hybrid Automatic Repeat and reQuest (HARQ)-related information. In addition, the eNB transmits uplink scheduling information for uplink data to inform a corresponding UE of available time/frequency domains, coding, data size, and HARQ-related information. An interface for transmitting user traffic or control traffic may be used between eNBs. A Core Network (CN) may include an AG and a network node for user registration of the UE. The AG manages mobility of the UE on a Tracking Area (TA) basis, wherein one TA consists of a plurality of cells.

Although radio communication technology has been developed up to LTE based on Wideband Code Division Multiple Access (WCDMA), demands and expectations of users and service providers have continued to increase. In addition, since other radio access technologies continue to be developed, new technical evolution is required for future competitiveness. Decrease of cost per bit, increase of service availability, flexible use of a frequency band, simple structure and open interface, and suitable power consumption by a UE are required.

3GPP is currently working on standardization of technology subsequent to LTE. The above technology is called ‘LTE-A’ in this specification. An LTE-A system is aimed to support a broadband of up to 100 MHz, and thus applies Carrier Aggregation (CA) capable of achieving a broadband using multiple frequency blocks. The CA technology uses multiple frequency blocks as one large logic frequency band to use a wider frequency band. The bandwidth of each frequency block may be defined based on the bandwidth of system blocks used in the LTE system. Each frequency block may be called a Component Carrier (CC) or a cell.

In addition, Multi-Input Multi-Output (MIMO) technology is a technology capable of improving data transmission/reception efficiency using multiple transmit (Tx) antennas and multiple receive (Rx) antennas instead of using a single Tx antenna and a single Rx antenna. A receiver using a single antenna receives data through a single antenna path, but a receiver using multiple antennas receives data through multiple paths. Accordingly, data transfer rate and data throughput may be improved, and coverage may be expanded.

To increase multiplexing gain of MIMO operation, a MIMO transmitter may receive and use channel state information (CSI) fed back from a MIMO receiver.

Extension and development of the MIMO system are expected. For example, an MIMO receiver (e.g., UE) as well as an MIMO transmitter (e.g., eNB) include multiple antennas (or an increased number of antennas compared to a legacy case) due to size increases of user devices, development of technologies, and cost reduction. If the number of antenna ports of the transmitter and/or the receiver is increased, time and frequency resources used to report CSI may be greatly increased and thus transmission efficiency may be remarkably reduced.

### DISCLOSURE

### Technical Problem

An object of the present invention devised to solve the problem lies in a method for reporting channel state information (CSI) in a wireless communication system, and an apparatus therefor.

It is to be understood that both the foregoing general description and the following detailed description of the present invention are exemplary and explanatory and are intended to provide further explanation of the invention as claimed.

### Technical Solution

The object of the present invention can be achieved by providing

a method for transmitting channel state information (CSI) by a user equipment (UE) in a wireless communication system, the method including receiving feedback antenna port configuration information from a base station (BS), and transmitting CSI of K (K≧1) feedback antenna ports to the BS in each of N (N≧2) reporting resources. The K feedback antenna ports may correspond to a part of M (M≧2) antenna ports. The CSI of the K feedback antenna ports may include phase information of the K feedback antenna ports. The phase information of the K feedback antenna ports may be determined by assuming phase differences based on a reference antenna port.

In another aspect of the present invention, provided herein is a method for receiving channel state information (CSI) by a base station (BS) in a wireless communication system, the method including transmitting feedback antenna port configuration information to a user equipment (UE), and receiving CSI of K (K≧1) feedback antenna ports from the UE in each of N (N≧2) reporting resources. The K feedback antenna ports may correspond to a part of M (M≧2) antenna ports. The CSI of the K feedback antenna ports may include phase information of the K feedback antenna ports. The phase information of the K feedback antenna ports may be determined by assuming phase differences based on a reference antenna port.

In another aspect of the present invention, provided herein is a user equipment (UE) for transmitting channel state information (CSI) in a wireless communication system, the UE including a transmitter module, a receiver module, and a processor. The processor may be configured to control the receiver module to receive feedback antenna port configuration information from a base station (BS), and control the transmitter module to transmit CSI of K (K≧1) feedback antenna ports to the BS in each of N (N≧2) reporting resources. The K feedback antenna ports may correspond to a part of M (M≧2) antenna ports. The CSI of the K feedback antenna ports may include phase information of the K feedback antenna ports. The phase information of the K feedback antenna ports may be determined by assuming phase differences based on a reference antenna port.

In another aspect of the present invention, provided herein is a base station (BS) for receiving channel state information (CSI) in a wireless communication system, the BS including a transmitter module, a receiver module, and a processor. The processor may be configured to control the transmitter module to transmit feedback antenna port configuration information to a user equipment (UE), and control the receiver module to receive CSI of K (K≧1) feedback antenna ports from the UE in each of N (N≧2) reporting resources. The K feedback antenna ports may correspond to a part of M (M≧2) antenna ports. The CSI of the K feedback antenna ports may include phase information of the K feedback antenna ports. The phase information of the K feedback antenna ports may be determined by assuming phase differences based on a reference antenna port.

The following is commonly applicable to the above aspects of the present invention.

The reference antenna port may be configured equally in the N reporting resources.

If the reference antenna port is configured differently in the N reporting resources, the phase information of the K feedback antenna ports may be determined by assuming phase alignment based on the reference antenna port.

Codebooks having different resolutions may be applied to the N reporting resources or to reporting resource groups.

The N reporting resources may include one or more pieces of CSI of each of the M antenna ports.

Phase information of a specific antenna port among the M antenna ports may be determined by assuming one or more of accumulation and a weighted average of phase information corresponding to the specific antenna port and transmitted in the N reporting resources.

The feedback antenna port configuration information may include one or more of a value of N, a value of K, a value of M, and index information of the K feedback antenna ports allocated to each of the N reporting resources.

The K feedback antenna ports may include one or more of antenna ports having different antenna port indexes in the N reporting resources.

The N reporting resources may be configured as a combination of one or more time resources and one or more frequency resources.

The CSI may further include receive (Rx) antenna port index information of the UE.

The CSI may be reported periodically or aperiodically.

It is to be understood that both the foregoing general description and the following detailed description of the present invention are exemplary and explanatory and are intended to provide further explanation of the invention as claimed.

### Advantageous Effects

According to an embodiment of the present invention, channel state information (CSI) may be accurately and efficiently reported in a wireless communication system.

It will be appreciated by persons skilled in the art that the effects that could be achieved through the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention, illustrate embodiments of the invention and together with the description serve to explain the principle of the invention. In the drawings:

FIG. 1 is a view schematically illustrating the network architecture of an Evolved Universal Mobile Telecommunications System (E-UMTS) as an exemplary wireless communication system;

FIG. 2 is a view illustrating structures of a control plane and a user plane of a radio interface protocol between a UE and an Evolved-Universal Terrestrial Radio Access Network (E-UTRAN) based on the 3GPP radio access network specification;

FIG. 3 is a view illustrating physical channels used in a 3GPP system and a general signal transmission method using the same;

FIG. 4 is a view illustrating the structure of a radio frame used in an LTE system;

FIG. 5 is a view illustrating the structure of a downlink radio frame used in the LTE system;

FIG. 6 is a view illustrating the structure of an uplink radio frame used in the LTE system;

FIG. 7 is a structural view of a general Multi-Input Multi-Output (MIMO) communication system;

FIGS. 8 and 9 are views showing the structures of downlink reference signals in an LTE system supporting downlink transmission using 4 antennas;

FIG. 10 is a view illustrating downlink demodulation-reference signal (DM-RS) allocation currently defined in the 3GPP specification;

FIG. 11 exemplarily illustrates CSI-RS configuration #0 in the case of a normal cyclic prefix (CP) among downlink CSI-RS configurations currently defined in the 3GPP specification;

FIG. 12 is a view showing the concept of massive MIMO technology;

FIGS. 13 and 14 are flowcharts for describing CSI feedback operation according to the present invention;

FIG. 15 is a view for describing a repeated CSI feedback method according to the present invention;

FIG. 16 is a view conceptually showing phase information per antenna port which is reported in each transmission frame;

FIGS. 17 to 19 are views showing examples of a feedback antenna port configuration method according to the present invention;

FIG. 20 is a table for comparing average correlation power of cases in which schemes proposed by the present invention are applied, to that of cases in which legacy beamforming schemes are applied;

FIG. 21 shows a result of comparing average correlation power of cases in which schemes proposed by the present invention are applied, to that of a case in which an 8Tx codebook of an LTE system is applied;

FIGS. 22 and 23 show results of comparing average correlation power of cases in which schemes proposed by the present invention are applied, to that of a case in which an 8Tx codebook of an LTE system is applied, in a channel with noise;

FIG. 24 is a view for describing an environment for testing a user transfer rate and a signal-to-interference-plus-noise ratio (SINR);

FIGS. 25 and 26 show a result of comparing the SINR and the user transfer rate in an environment where a total number of antenna ports of an eNB is 16; and

FIG. 27 is a block diagram of a UE and a BS according to an embodiment of the present invention.

### BEST MODE

Hereinafter, the structures, operations, and other features of the present invention will be understood readily from the embodiments of the present invention, examples of which are described with reference to the accompanying drawings. The embodiments which will be described below are examples in which the technical features of the present invention are applied to a 3GPP system.

Although the embodiments of the present invention will be described based on an LTE system and an LTE-Advanced (LTE-A) system, the LTE system and the LTE-A system are only exemplary and the embodiments of the present invention can be applied to all communication systems corresponding to the aforementioned definition. In addition, although the embodiments of the present invention will herein be described based on Frequency Division Duplex (FDD) mode, the FDD mode is only exemplary and the embodiments of the present invention can easily be modified and applied to Half-FDD (H-FDD) mode or Time Division Duplex (TDD) mode.

In this specification, the term “base station (BS)” may be comprehensively used to include remote radio head (RRH), evolved node B (eNB), transmission point (TP), reception point (RP), relay, etc. Furthermore, if Carrier Aggregation (CA) is applied, operation of the BS described according to the present invention may also be applied to a Component Carrier (CC) or a cell.

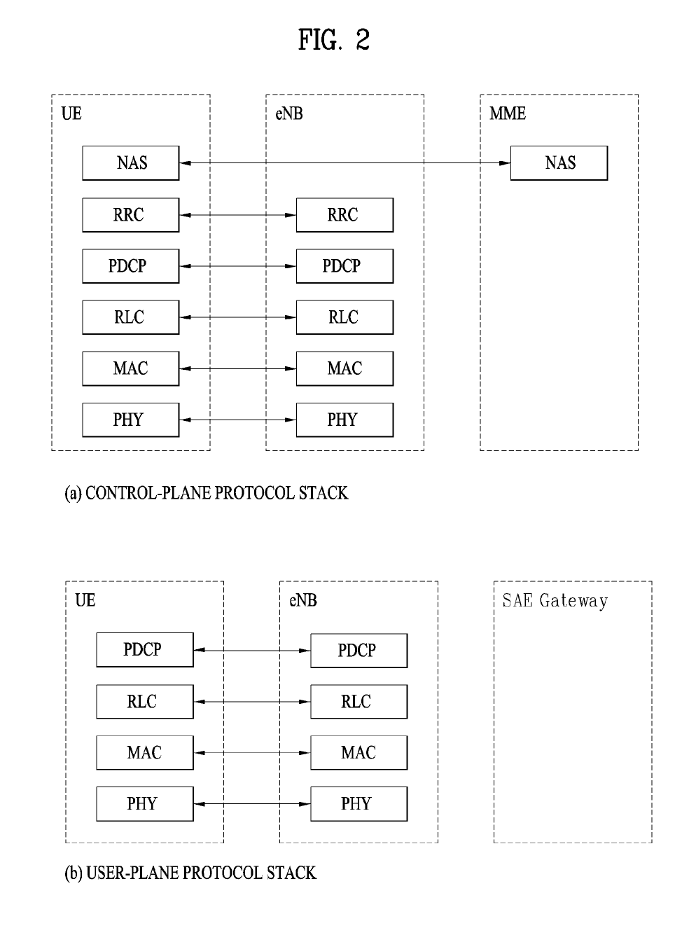

FIG. 2 is a view illustrating structures of a control plane and a user plane of a radio interface protocol between a UE and an E-UTRAN based on the 3GPP radio access network specification. The control plane refers to a path through which control messages used by a User Equipment (UE) and a network to manage a call are transmitted. The user plane refers to a path through which data generated in an application layer, e.g. voice data or Internet packet data, is transmitted.

A physical layer of a first layer provides an information transfer service to an upper layer using a physical channel. The physical layer is connected to a Medium Access Control (MAC) layer of an upper layer via a transport channel. Data is transported between the MAC layer and the physical layer via the transport channel. Data is also transported between a physical layer of a transmitting side and a physical layer of a receiving side via a physical channel. The physical channel uses time and frequency as radio resources. Specifically, the physical channel is modulated using an Orthogonal Frequency Division Multiple Access (OFDMA) scheme in downlink and is modulated using a Single-Carrier Frequency Division Multiple Access (SC-FDMA) scheme in uplink.

A MAC layer of a second layer provides a service to a Radio Link Control (RLC) layer of an upper layer via a logical channel. The RLC layer of the second layer supports reliable data transmission. The function of the RLC layer may be implemented by a functional block within the MAC. A Packet Data Convergence Protocol (PDCP) layer of the second layer performs a header compression function to reduce unnecessary control information for efficient transmission of an Internet Protocol (IP) packet such as an IPv4 or IPv6 packet in a radio interface having a relatively narrow bandwidth.

A Radio Resource Control (RRC) layer located at the bottommost portion of a third layer is defined only in the control plane. The RRC layer controls logical channels, transport channels, and physical channels in relation to configuration, re-configuration, and release of radio bearers. The radio bearers refer to a service provided by the second layer to transmit data between the UE and the network. To this end, the RRC layer of the UE and the RRC layer of the network exchange RRC messages. The UE is in an RRC connected mode if an RRC connection has been established between the RRC layer of the radio network and the RRC layer of the UE. Otherwise, the UE is in an RRC idle mode. A Non-Access Stratum (NAS) layer located at an upper level of the RRC layer performs functions such as session management and mobility management.

One cell of an eNB is set to use one of bandwidths such as 1.25, 2.5, 5, 10, 15, and 20 MHz to provide a downlink or uplink transmission service to a plurality of UEs. Different cells may be set to provide different bandwidths.

Downlink transport channels for data transmission from a network to a UE include a Broadcast Channel (BCH) for transmitting system information, a Paging Channel (PCH) for transmitting paging messages, and a downlink Shared Channel (SCH) for transmitting user traffic or control messages. Traffic or control messages of a downlink multicast or broadcast service may be transmitted through the downlink SCH or may be transmitted through an additional downlink Multicast Channel (MCH). Meanwhile, uplink transport channels for data transmission from the UE to the network include a Random Access Channel (RACH) for transmitting initial control messages and an uplink SCH for transmitting user traffic or control messages. Logical channels, which are located at an upper level of the transport channels and are mapped to the transport channels, include a Broadcast Control Channel (BCCH), a Paging Control Channel (PCCH), a Common Control Channel (CCCH), a Multicast Control Channel (MCCH), and a Multicast Traffic Channel (MTCH).

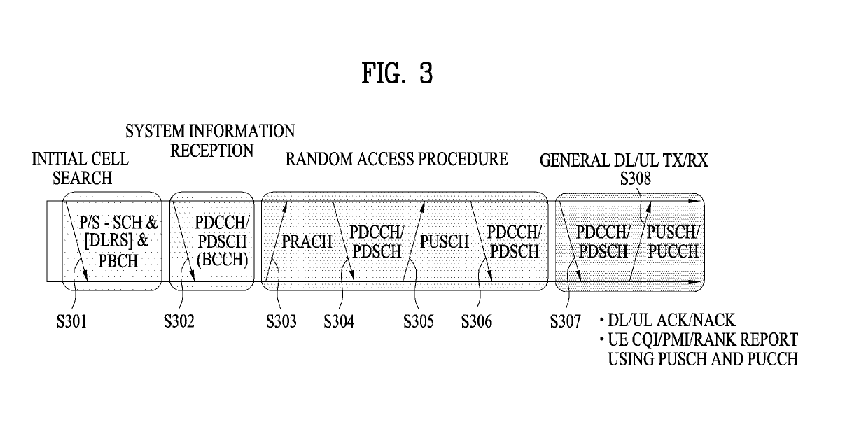

FIG. 3 is a view illustrating physical channels used in a 3GPP system and a general signal transmission method using the same.

A UE performs initial cell search such as establishment of synchronization with an eNB when power is turned on or the UE enters a new cell (step S301). The UE may receive a Primary Synchronization Channel (P-SCH) and a Secondary Synchronization Channel (S-SCH) from the eNB, establish synchronization with the eNB, and acquire information such as a cell identity (ID). Thereafter, the UE may receive a physical broadcast channel from the eNB to acquire broadcast information within the cell. Meanwhile, the UE may receive a Downlink Reference Signal (DL RS) in the initial cell search step to confirm a downlink channel state.

Upon completion of initial cell search, the UE may receive a Physical Downlink Control Channel (PDCCH) and a Physical Downlink Shared Channel (PDSCH) according to information carried on the PDCCH to acquire more detailed system information (step S302).

Meanwhile, if the UE initially accesses the eNB or if radio resources for signal transmission are not present, the UE may perform a random access procedure (steps S303 to S306) with respect to the eNB. To this end, the UE may transmit a specific sequence through a Physical Random Access Channel (PRACH) as a preamble (steps S303 and S305), and receive a response message to the preamble through the PDCCH and the PDSCH corresponding thereto (steps S304 and S306). In the case of a contention-based RACH, a contention resolution procedure may be additionally performed.

The UE which performs the above procedures may receive a PDCCH/PDSCH (step S307) and transmit a Physical Uplink Shared Channel (PUSCH)/Physical Uplink Control Channel (PUCCH) (step S308) according to a general uplink/downlink signal transmission procedure. Especially, the UE receives Downlink Control Information (DCI) through the PDCCH. The DCI includes control information such as resource allocation information for the UE and has different formats according to use purpose.

Meanwhile, control information, transmitted by the UE to the eNB through uplink or received by the UE from the eNB through downlink, includes a downlink/uplink ACKnowledgment/Negative ACKnowledgment (ACK/NACK) signal, a Channel Quality Indicator (CQI), a Precoding Matrix Index (PMI), a Rank Indicator (RI), and the like. In the case of the 3GPP LTE system, the UE may transmit control information such as CQI/PMI/RI through the PUSCH and/or the PUCCH.

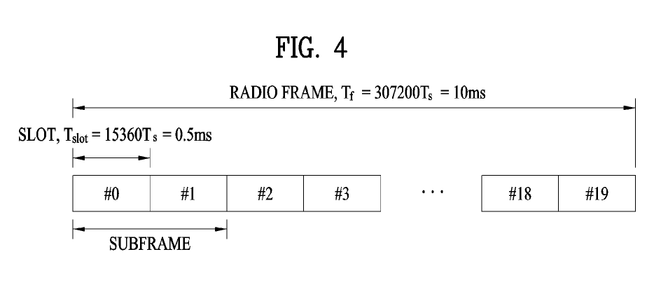

FIG. 4 is a view illustrating the structure of a radio frame used in an LTE system.

Referring to FIG. 4, the radio frame has a length of 10 ms (327200 Ts) and includes 10 equally-sized subframes. Each of the subframes has a length of 1 ms and includes two slots. Each of the slots has a length of 0.5 ms (15360 Ts). In this case, Ts denotes sampling time and is represented by Ts=1/(15 kHz×2048)=3.2552×10-8 (about 33 ns). Each slot includes a plurality of OFDM symbols in a time domain and includes a plurality of Resource Blocks (RBs) in a frequency domain. In the LTE system, one resource block includes 12 subcarriers×7 (or 6) OFDM symbols. A Transmission Time Interval (TTI), which is a unit time for data transmission, may be determined in units of one or more subframes. The above-described structure of the radio frame is purely exemplary and various modifications may be made in the number of subframes included in a radio frame, the number of slots included in a subframe, or the number of OFDM symbols included in a slot.

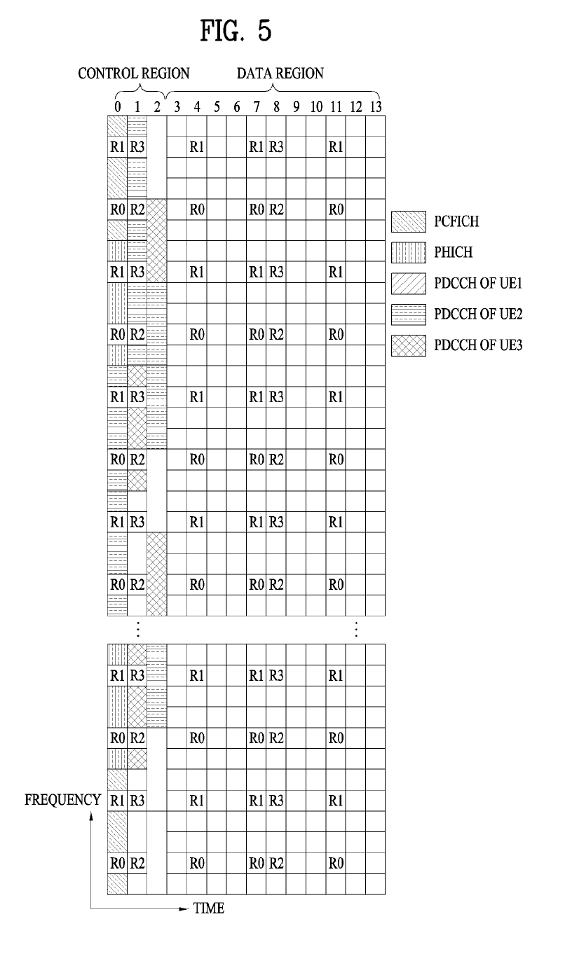

FIG. 5 is a view illustrating control channels contained in a control region of one subframe in a downlink radio frame.

Referring to FIG. 5, one subframe includes 14 OFDM symbols. The first to third ones of the 14 OFDM symbols may be used as a control region and the remaining 13 to 11 OFDM symbols may be used as a data region, according to subframe configuration. In FIGS. 5, R1 to R4 represent reference signals (RSs) or pilot signals for antennas 0 to 3, respectively. The RSs are fixed to a predetermined pattern within the subframe irrespective of the control region and the data region. Control channels are allocated to resources to which the RS is not allocated in the control region. Traffic channels are allocated to resources, to which the RS is not allocated, in the data region. The control channels allocated to the control region include a Physical Control Format Indicator Channel (PCFICH), a Physical Hybrid-ARQ Indicator Channel (PHICH), a Physical Downlink Control Channel (PDCCH), etc.

The PCFICH, physical control format indicator channel, informs a UE of the number of OFDM symbols used for the PDCCH per subframe. The PCFICH is located in the first OFDM symbol and is established prior to the PHICH and the PDCCH. The PCFICH is comprised of 4 Resource Element Groups (REGs) and each of the REGs is distributed in the control region based on a cell ID. One REG includes 4 Resource Elements (REs). The RE indicates a minimum physical resource defined as one subcarrier x one OFDM symbol. The PCFICH value indicates values of 1 to 3 or values of 2 to 4 depending on bandwidth and is modulated by Quadrature Phase Shift Keying (QPSK).

The PHICH, physical Hybrid-ARQ indicator channel, is used to transmit a HARQ ACK/NACK signal for uplink transmission. That is, the PHICH indicates a channel through which downlink ACK/NACK information for uplink HARQ is transmitted. The PHICH includes one REG and is cell-specifically scrambled. The ACK/NACK signal is indicated by 1 bit and is modulated by Binary Phase Shift Keying (BPSK). The modulated ACK/NACK signal is spread by a Spreading Factor (SF)=2 or 4. A plurality of PHICHs mapped to the same resource constitutes a PHICH group. The number of PHICHs multiplexed to the PHICH group is determined depending on the number of SFs. The PHICH (group) is repeated three times to obtain diversity gain in a frequency domain and/or a time domain.

The PDCCH, physical downlink control channel, is allocated to the first n OFDM symbols of a subframe. In this case, n is an integer greater than 1 and is indicated by the PCFICH. The PDCCH is comprised of one or more Control Channel Elements (CCEs). The PDCCH informs each UE or UE group of information associated with resource allocation of a Paging Channel (PCH) and a Downlink-Shared Channel (DL-SCH), uplink scheduling grant, Hybrid Automatic Repeat Request (HARQ) information, etc. Therefore, an eNB and a UE transmit and receive data other than specific control information or specific service data through the PDSCH.

Information indicating to which UE or UEs PDSCH data is to be transmitted, information indicating how UEs are to receive PDSCH data, and information indicating how UEs are to perform decoding are contained in the PDCCH. For example, it is assumed that a specific PDCCH is CRC-masked with a Radio Network Temporary Identity (RNTI) “A” and information about data, that is transmitted using radio resources “B” (e.g., frequency location) and transport format information “C” (e.g., transmission block size, modulation scheme, coding information, etc.), is transmitted through a specific subframe. In this case, a UE located in a cell monitors (i.e. blind decoding) the PDCCH in search space using its own RNTI information. If one or more UEs having the RNTI ‘A’ are present, the UEs receive the PDCCH and receive the PDSCH indicated by ‘B’ and ‘C’ through the received PDCCH information.

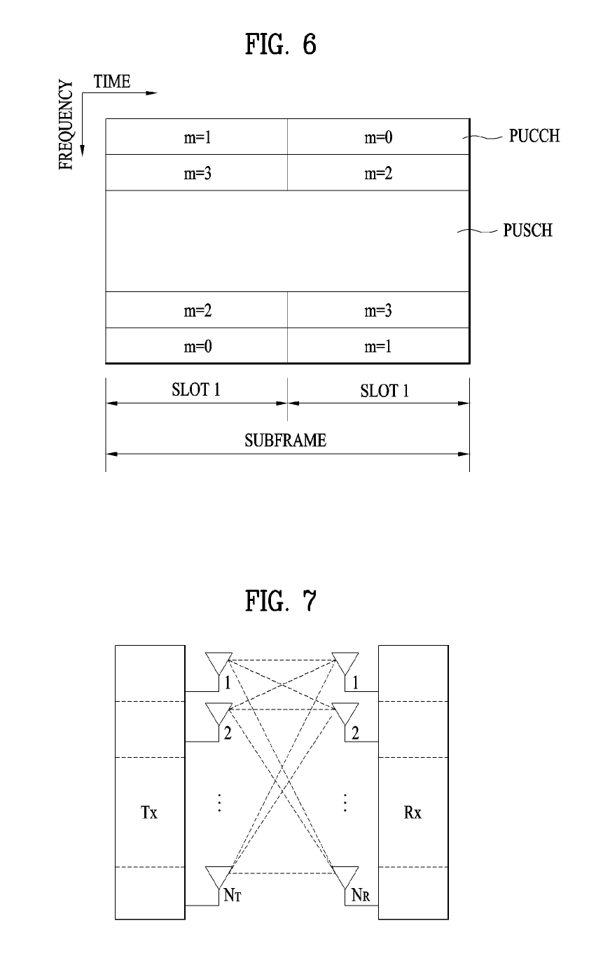

FIG. 6 illustrates the structure of an uplink subframe used in the LTE system.

Referring to FIG. 6, an uplink subframe is divided into a region to which a PUCCH is allocated to transmit control information and a region to which a PUSCH is allocated to transmit user data. The PUSCH is allocated to the middle of the subframe, whereas the PUCCH is allocated to both ends of a data region in the frequency domain. The control information transmitted on the PUCCH includes an ACK/NACK, a CQI representing a downlink channel state, an RI for Multiple Input and Multiple Output (MIMO), a Scheduling Request (SR) indicating a request for allocation of uplink resources, etc. A PUCCH of a UE occupies one RB in a different frequency in each slot of a subframe. That is, two RBs allocated to the PUCCH frequency-hop over the slot boundary. Particularly, FIG. 6 illustrates an example in which PUCCHs for m=0, m=1, m=2, and m=3 are allocated to a subframe.

Hereinafter, a MIMO system will be described. MIMO refers to a method of using multiple transmission antennas and multiple reception antennas to improve data transmission/reception efficiency. Namely, a plurality of antennas is used at a transmitting end or a receiving end of a wireless communication system so that capacity can be increased and performance can be improved. MIMO may also be referred to as ‘multi-antenna’ in this disclosure.

MIMO technology does not depend on a single antenna path in order to receive a whole message. Instead, MIMO technology collects data fragments received via several antennas, merges the data fragments, and forms complete data. The use of MIMO technology can increase system coverage while improving data transfer rate within a cell area of a specific size or guaranteeing a specific data transfer rate. MIMO technology can be widely used in mobile communication terminals and relay nodes. MIMO technology can overcome the limitations of the restricted amount of transmission data of single antenna based mobile communication systems.

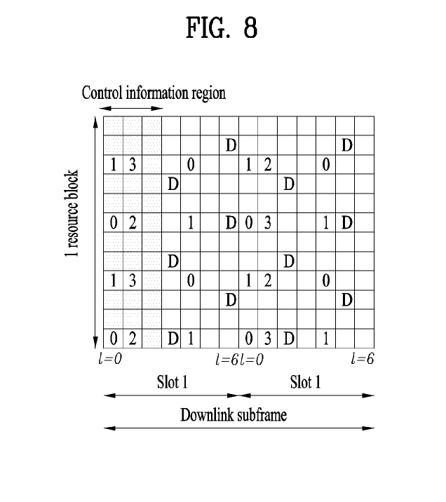

The configuration of a general MIMO communication system is shown in FIG. 7. A transmitting end is equipped with NT transmission (Tx) antennas and a receiving end is equipped with NR reception (Rx) antennas. If a plurality of antennas is used both at the transmitting end and at the receiving end, theoretical channel transmission capacity increases unlike the case where only either the transmitting end or the receiving end uses a plurality of antennas. Increase in channel transmission capacity is proportional to the number of antennas, thereby improving transfer rate and frequency efficiency. If a maximum transfer rate using a signal antenna is Ro, a transfer rate using multiple antennas can be theoretically increased by the product of the maximum transfer rate Ro by a rate increment Ri. The rate increment Ri is represented by the following equation 1 where Ri is the smaller of NT and NR.

Rᵢ=min(N_{T},N_{R}) [Equation 1]

For example, in a MIMO communication system using four Tx antennas and four Rx antennas, it is possible to theoretically acquire a transfer rate four times that of a single antenna system. After theoretical increase in the capacity of the MIMO system was first demonstrated in the mid-1990s, various techniques for substantially improving data transfer rate have been under development. Several of these techniques have already been incorporated into a variety of wireless communication standards including, for example, 3rd generation mobile communication and next-generation wireless local area networks.

Active research up to now related to MIMO technology has focused upon a number of different aspects, including research into information theory related to MIMO communication capacity calculation in various channel environments and in multiple access environments, research into wireless channel measurement and model derivation of MIMO systems, and research into space-time signal processing technologies for improving transmission reliability and transfer rate.

To describe a communication method in a MIMO system in detail, a mathematical model thereof is given below. As shown in FIG. 7, it is assumed that NT Tx antennas and NR Rx antennas are present. In the case of a transmission signal, a maximum number of transmittable pieces of information is NT under the condition that NT Tx antennas are used, so that transmission information can be represented by a vector represented by the following equation 2:

S=[S₁,S₂, . . . ,S_{N}_{_{T}}]^{T} [Equation 2]

Meanwhile, individual transmission information pieces S₁, S₂, . . . , S_{N}_{_{T}} may have different transmission powers. In this case, if the individual transmission powers are denoted by P₁, P₂, . . . , P_{N}_{_{T}}, transmission information having adjusted transmission powers can be represented by a vector shown in the following equation 3:

Ŝ=[Ŝ₁,Ŝ₂, . . . ,Ŝ_{N}_{_{T}}]^{T}=[P₁S₁,P₂S₂, . . . ,P_{N}_{_{T}}S_{N}_{_{T}}]^{T} [Equation 3]

The transmission power-controlled transmission information vector Ŝ may be expressed as follows, using a diagonal matrix P of a transmission power:

$$\hat{s} = [ \begin{matrix}{P}_{1} & & & 0 \\ & {P}_{2} & & \\ & & ⋱ & \\ 0 & & & {P}_{{N}_{T}}\end{matrix} ] [ \begin{matrix}{s}_{1 } \\ {s}_{2 } \\ ⋮ \\ {s}_{{N}_{T}}\end{matrix} ] = Ps \qquad [ Equation 4 ]$$

NT transmission signals x₁, x₂, . . . , x_{N}_{_{T}} to be actually transmitted may be configured by multiplying the transmission power-controlled information vector Ŝ by a weight matrix W. In this case, the weight matrix is adapted to properly distribute transmission information to individual antennas according to transmission channel situations. The transmission signals x₁, x₂, . . . , x_{N}_{_{T}} can be represented by the following Equation 5 using a vector X. In Equation 5, Wᵢⱼ is a weight between the i-th Tx antenna and the j-th information and W is a weight matrix, which may also be referred to as a precoding matrix.

$$x = [ \begin{matrix}{x}_{1} \\ {x}_{2} \\ ⋮ \\ {x}_{i} \\ ⋮ \\ {x}_{{N}_{T}}\end{matrix} ] [ \begin{matrix}{w}_{11} & {w}_{12 } & ⋯ & {w}_{1 {N}_{T}} \\ {w}_{21 } & {w}_{22 } & ⋯ & {w}_{2 {N}_{T}} \\ ⋮ & & ⋱ & \\ {w}_{i 1 } & {w}_{i 2 } & ⋯ & {w}_{{iN}_{T}} \\ ⋮ & & ⋱ & \\ {w}_{{N}_{T} 1} & {w}_{{N}_{T} 2} & ⋯ & {w}_{{N}_{T} {N}_{T}}\end{matrix} ] [ \begin{matrix}{\hat{s}}_{1} \\ {\hat{s}}_{2} \\ ⋮ \\ {\hat{s}}_{j} \\ ⋮ \\ {\hat{s}}_{{N}_{T}}\end{matrix} ] = W \hat{s} = WPs \qquad [ Equation 5 ]$$

Generally, the physical meaning of a rank of a channel matrix may be a maximum number of different pieces of information that can be transmitted in a given channel. Accordingly, since the rank of the channel matrix is defined as the smaller of the number of rows or columns, which are independent of each other, the rank of the matrix is not greater than the number of rows or columns. A rank of a channel matrix H, rank(H), is restricted as follows.

rank(H)≦min(N_{T},N_{R}) [Equation 6]

Each unit of different information transmitted using MIMO technology is defined as a ‘transmission stream’ or simply ‘stream’. The ‘stream’ may be referred to as a ‘layer’. The number of transmission streams is not greater than a rank of a channel which is a maximum number of different pieces of transmittable information. Accordingly, the channel matrix H may be indicted by the following Equation 7:

# of streams rank(H)≦min(N_{T},N_{R}) [Equation 7]

where ‘# of streams’ denotes the number of streams. It should be noted that one stream may be transmitted through one or more antennas.

There may be various methods of allowing one or more streams to correspond to multiple antennas. These methods may be described as follows according to types of MIMO technology. The case where one stream is transmitted via multiple antennas may be called spatial diversity, and the case where multiple streams are transmitted via multiple antennas may be called spatial multiplexing. It is also possible to configure a hybrid of spatial diversity and spatial multiplexing.

A detailed description is now given of reference signals (RSs).

In general, a reference signal known to both a transmitter and a receiver is transmitted from the transmitter to the receiver for channel measurement together with data. This reference signal indicates a modulation scheme as well as a channel measurement scheme to perform a demodulation procedure. The reference signal is divided into a dedicated RS (DRS), i.e., a UE-specific RS, for a BS and a specific UE, and a common RS (CRS), i.e., a cell-specific RS, for all UEs in a cell. In addition, the cell-specific RS includes a reference signal for reporting CQI/PMI/RI measured by the UE to the BS, which is called a channel state information-RS (CSI-RS).

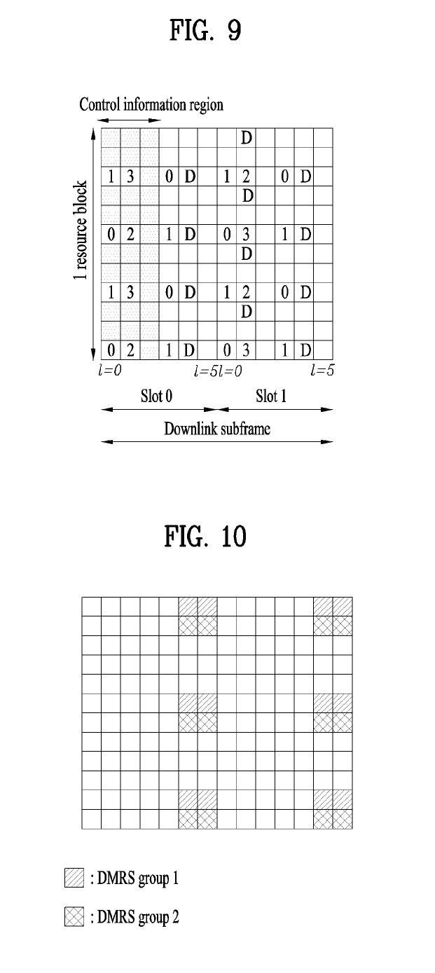

FIGS. 8 and 9 are views showing the structures of reference signals in an LTE system supporting downlink transmission using 4 antennas. Specifically, FIG. 8 illustrates the case of a normal cyclic prefix (CP), and FIG. 9 illustrates the case of an extended CP.

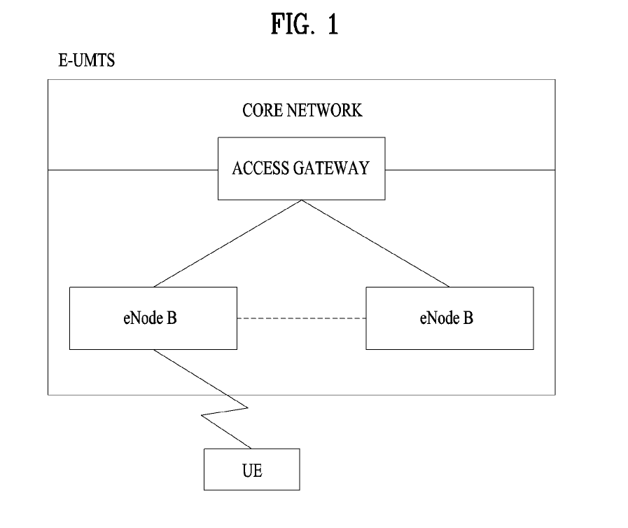

Referring to FIGS. 8 and 9, 0 to 3 marked in the grid denote common RSs (CRSs) which are cell-specific RSs transmitted through antenna ports 0 to 3 for channel measurement and data demodulation, and the CRSs which are the cell-specific RSs can be transmitted to UEs over a control information region as well as a data information region.

In addition, ‘D’ marked in the grid denotes a downlink demodulation-reference signal (DM-RS) which is a UE-specific RS, and the DM-RS supports single antenna port transmission through a data region, i.e., PDSCH. The UE receives a higher layer signal indicating whether a DM-RS, which is a UE-specific RS, is present. FIGS. 8 and 9 exemplarily illustrate a DM-RS corresponding to antenna port 5, and 3GPP 36.211 also defines DM-RSs corresponding to antenna ports 7 to 14, i.e., a total of 8 antenna ports.

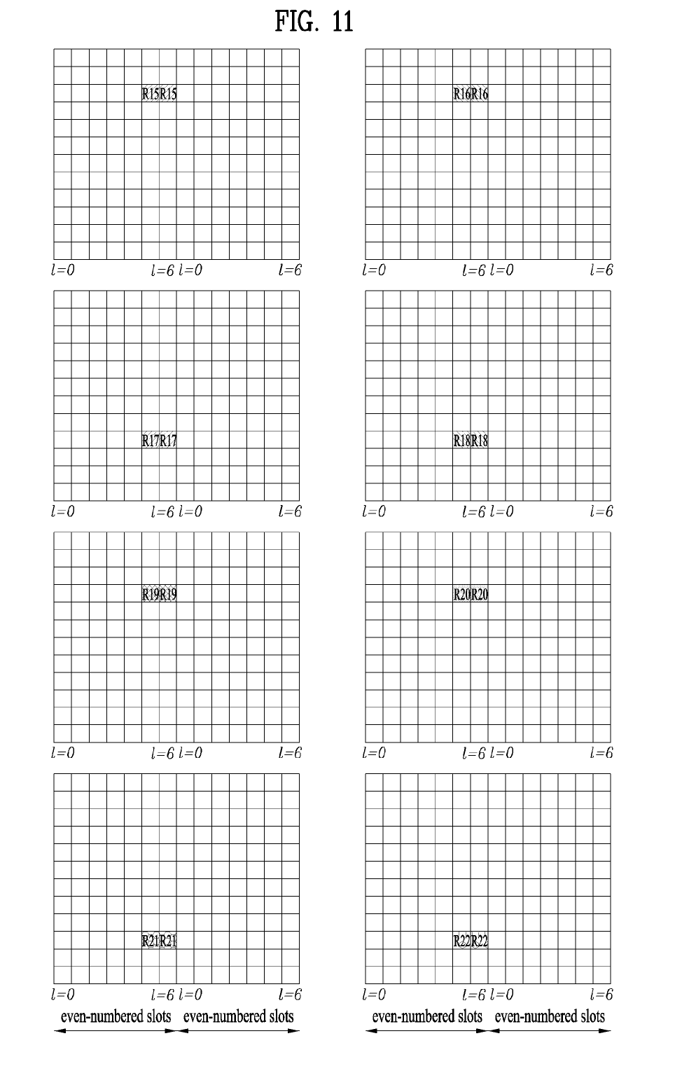

FIG. 10 exemplarily illustrates downlink DM-RS allocation currently defined in the 3GPP specification.

Referring to FIG. 10, DM-RSs corresponding to antenna ports {7, 8, 11, 13} are mapped to DM-RS group 1 using antenna port sequences, and DM-RSs corresponding to antenna ports {9, 10, 12, 14} are mapped to DM-RS group 2 using antenna port sequences.

Meanwhile, unlike CRS, CSI-RS has been proposed above for PDSCH channel measurement, and can be defined as up to 32 different CSI-RS configurations to reduce inter-cell interference (ICI) in a multiple-cell environment.

The CSI-RS configuration differs depending on the number of antenna ports, and neighboring cells are configured to transmit CSI-RSs defined as different CSI-RS configurations as possible. Unlike CRS, CSI-RS supports up to 8 antenna ports, and a total of 8 antenna ports from antenna port 15 to antenna port 22 are allocated as antenna ports for CSI-RS in the 3GPP specification. Tables 1 and 2 show CSI-RS configurations defined in the 3GPP specification. Specifically, Table 1 shows the case of a normal CP, and Table 2 shows the case of an extended CP.

TABLE 1

| | CSI | Number of CSI reference signals configured | | | | | |
|---|---|---|---|---|---|---|---|
| | reference | 1 or 2 | | 4 | | 8 | |
| | signal | | nₛ | | nₛ | | nₛ |
| | config- | (k′, | mod | (k′, | mod | (k′, | mod |
| | uration | l′) | 2 | l′) | 2 | l′) | 2 |
| Frame | 0 | (9, 5) | 0 | (9, 5) | 0 | (9, 5) | 0 |
| structure | 1 | (11, 2) | 1 | (11, 2) | 1 | (11, 2) | 1 |
| type 1 | 2 | (9, 2) | 1 | (9, 2) | 1 | (9, 2) | 1 |
| and 2 | 3 | (7, 2) | 1 | (7, 2) | 1 | (7, 2) | 1 |
| | 4 | (9, 5) | 1 | (9, 5) | 1 | (9, 5) | 1 |
| | 5 | (8, 5) | 0 | (8, 5) | 0 | | |
| | 6 | (10, 2) | 1 | (10, 2) | 1 | | |
| | 7 | (8, 2) | 1 | (8, 2) | 1 | | |
| | 8 | (6, 2) | 1 | (6, 2) | 1 | | |
| | 9 | (8, 5) | 1 | (8, 5) | 1 | | |
| | 10 | (3, 5) | 0 | | | | |
| | 11 | (2, 5) | 0 | | | | |
| | 12 | (5, 2) | 1 | | | | |
| | 13 | (4, 2) | 1 | | | | |
| | 14 | (3, 2) | 1 | | | | |
| | 15 | (2, 2) | 1 | | | | |
| | 16 | (1, 2) | 1 | | | | |
| | 17 | (0, 2) | 1 | | | | |
| | 18 | (3, 5) | 1 | | | | |
| | 19 | (2, 5) | 1 | | | | |
| Frame | 20 | (11, 1) | 1 | (11, 1) | 1 | (11, 1) | 1 |
| structure | 21 | (9, 1) | 1 | (9, 1) | 1 | (9, 1) | 1 |
| type 2 | 22 | (7, 1) | 1 | (7, 1) | 1 | (7, 1) | 1 |
| only | 23 | (10, 1) | 1 | (10, 1) | 1 | | |
| | 24 | (8, 1) | 1 | (8, 1) | 1 | | |
| | 25 | (6, 1) | 1 | (6, 1) | 1 | | |
| | 26 | (5, 1) | 1 | | | | |
| | 27 | (4, 1) | 1 | | | | |
| | 28 | (3, 1) | 1 | | | | |
| | 29 | (2, 1) | 1 | | | | |
| | 30 | (1, 1) | 1 | | | | |
| | 31 | (0, 1) | 1 | | | | |

TABLE 2

| | CSI | Number of CSI reference signals configured | | | | | |
|---|---|---|---|---|---|---|---|
| | reference | 1 or 2 | | 4 | | 8 | |
| | signal | | nₛ | | nₛ | | nₛ |
| | config- | (k′, | mod | (k′, | mod | (k′, | mod |
| | uration | l′) | 2 | l′) | 2 | l′) | 2 |
| Frame | 0 | (11, 4) | 0 | (11, 4) | 0 | (11, 4) | 0 |
| structure | 1 | (9, 4) | 0 | (9, 4) | 0 | (9, 4) | 0 |
| type 1 | 2 | (10, 4) | 1 | (10, 4) | 1 | (10, 4) | 1 |
| and 2 | 3 | (9, 4) | 1 | (9, 4) | 1 | (9, 4) | 1 |
| | 4 | (5, 4) | 0 | (5, 4) | 0 | | |
| | 5 | (3, 4) | 0 | (3, 4) | 0 | | |
| | 6 | (4, 4) | 1 | (4, 4) | 1 | | |
| | 7 | (3, 4) | 1 | (3, 4) | 1 | | |
| | 8 | (8, 4) | 0 | | | | |
| | 9 | (6, 4) | 0 | | | | |
| | 10 | (2, 4) | 0 | | | | |
| | 11 | (0, 4) | 0 | | | | |
| | 12 | (7, 4) | 1 | | | | |
| | 13 | (6, 4) | 1 | | | | |
| | 14 | (1, 4) | 1 | | | | |
| | 15 | (0, 4) | 1 | | | | |
| Frame | 16 | (11, 1) | 1 | (11, 1) | 1 | (11, 1) | 1 |
| structure | 17 | (10, 1) | 1 | (10, 1) | 1 | (10, 1) | 1 |
| type 2 | 18 | (9, 1) | 1 | (9, 1) | 1 | (9, 1) | 1 |
| only | 19 | (5, 1) | 1 | (5, 1) | 1 | | |
| | 20 | (4, 1) | 1 | (4, 1) | 1 | | |
| | 21 | (3, 1) | 1 | (3, 1) | 1 | | |
| | 22 | (8, 1) | 1 | | | | |
| | 23 | (7, 1) | 1 | | | | |
| | 24 | (6, 1) | 1 | | | | |
| | 25 | (2, 1) | 1 | | | | |
| | 26 | (1, 1) | 1 | | | | |
| | 27 | (0, 1) | 1 | | | | |

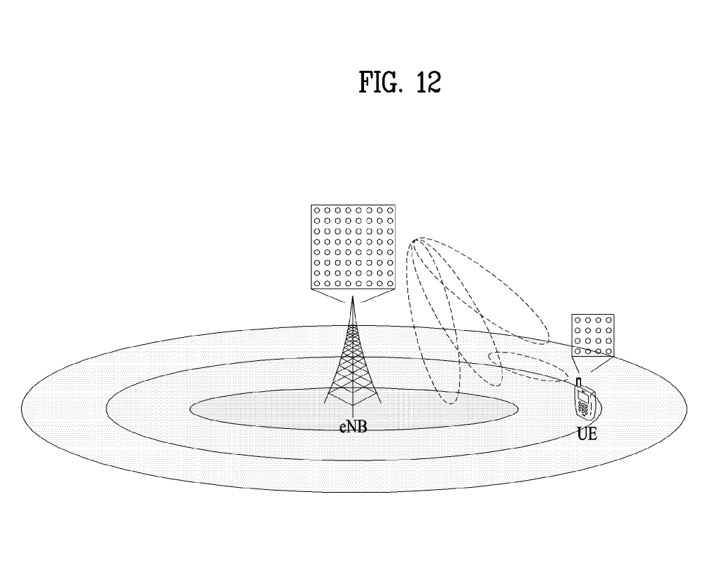

In Tables 1 and 2, (k′, l′) denotes an RE index, k′ denotes a subcarrier index, r denotes an OFDM symbol index. FIG. 11 exemplarily illustrates CSI-RS configuration #0 in the case of a normal CP among CSI-RS configurations currently defined in the 3GPP specification.

CSI-RS subframe configurations can also be defined, and each CSI-RS subframe configuration includes a periodicity T_{CSI-RS} and a subframe offset Δ_{CSI-RS} which are expressed on a subframe basis. Table 3 shows the CSI-RS subframe configurations defined in the 3GPP specification.

TABLE 3

| CSI-RS- | CSI-RS periodicity | CSI-RS subframe offset |
|---|---|---|
| SubframeConfig | T_{CSI-RS} | Δ_{CSI-RS} |
| I_{CSI-RS} | (subframes) | (subframes) |
| 0-4 | 5 | I_{CSI-RS} |
| 5-14 | 10 | I_{CSI-RS} − 5 |
| 15-34 | 20 | I_{CSI-RS} − 15 |
| 35-74 | 40 | I_{CSI-RS} − 35 |
| 75-154 | 80 | I_{CSI-RS} − 75 |

Enhanced CSI Feedback

A receiver (e.g., UE) may measure the state of a channel formed by each antenna port of a transmitter (e.g., eNB) and report a result thereof. Here, the receiver may determine or calculate RI, PMI and/or CQI using RS of each antenna port of the transmitter to measure the state of the channel. Here, the PMI is defined as an index value indicating an appropriate precoding matrix for the measured channel in view of the receiver, and the appropriate precoding matrix may be selected or determined in a set of precoding matrix candidates predetermined and shared between the transmitter and the receiver. Here, the set of the precoding matrix candidates is called a codebook. The PMI may indicate a precoding matrix appropriate for a specific rank.

Meanwhile, employment of an active antenna system (AAS) in a next-generation wireless communication system is under consideration. Unlike a legacy passive antenna separate from an amplifier capable of adjusting the phase and magnitude of a signal, an active antenna refers to an antenna including an active device such as an amplifier. The AAS does not require an additional cable, connector, other hardware, etc. for connecting the amplifier to the antenna, and has high efficiency in view of energy consumption and operating costs. Specifically, since electronic beam control per antenna is supported, the AAS allows advanced MIMO technology, e.g., precise beam pattern forming in consideration of beam direction and beam width or 3-dimensional (3D) beam pattern forming.

Due to employment of an advanced antenna system such as the above-described AAS, a massive MIMO structure having multiple I/O antennas and a multi-dimensional antenna structure is also under consideration. For example, unlike a legacy linear antenna array (or 1-dimensional (1D) antenna array), when a 2-dimensional (2D) antenna array is formed, a 3D beam pattern can be formed using active antennas of the AAS.

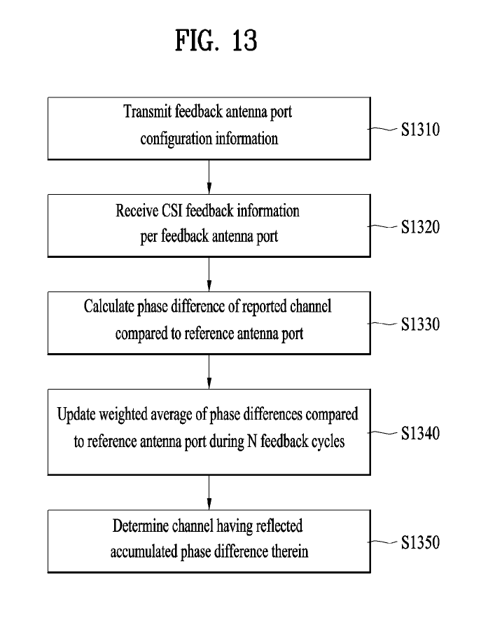

FIG. 12 is a view showing the concept of massive MIMO technology. Specifically, FIG. 12 illustrates a system in which the eNB or the UE has multiple Tx/Rx antennas capable of 3D beamforming based on an AAS system.

Referring to FIG. 12, when a 3D beam pattern is used in view of Tx antennas, quasi-static or dynamic beamforming can be performed not only in the horizontal beam direction but also in the vertical beam direction, and application such as vertical-direction sector forming can be considered. In view of Rx antennas, when Rx beams are formed using a massive Rx antenna, increase in signal power based on an antenna array gain may be expected. Accordingly, in the case of uplink, the eNB may receive signals transmitted from the UE, through multiple antennas. In this case, the UE may configure Tx power thereof to a very low level in consideration of a gain of the massive Rx antenna to reduce the influence of interference.

To perform 3D beamforming in this massive MIMO system, feedback of more precise CSI compared to legacy CSI is required. In addition, a new codebook should be defined or added to support an increased number of antenna ports as in the massive MIMO system. As such, feedback overhead may be increased. Furthermore, as the number of antenna ports is increased, the number of RSs for distinguishing between antenna ports is increased. As such, the number of resources (e.g., time, frequency and/or code resources) used to transmit the RSs may be increased and thus the number of resources to be used for data among all system resources may be reduced. That is, overhead for supporting the increased number of antenna ports may be increased and user data throughput may be reduced.

To solve this problem, the massive MIMO system requires a CSI feedback method capable of maximizing MIMO transmission efficiency. The present invention proposes a method for designing a codebook for the massive MIMO system supporting an increased number of antenna ports (or antenna elements), and reducing or mitigating feedback overhead of CSI reporting based on the codebook, as an enhanced CSI feedback method. In addition, the present invention proposes a method for allowing a transmitter to use CSI feedback information sent from a receiver according to the proposed CSI feedback method. Specifically, the present invention proposes a method for configuring feedback antenna ports, a method for acquiring channel information through repeated feedback, a method for configuring and feeding back phase information having a higher resolution based on a codebook having a restricted resolution, etc.

Although a transmitter of MIMO transmission (i.e., a receiver of feedback information) is an eNB and a receiver of MIMO transmission (i.e., a transmitter of feedback information) is a UE in the following examples of the present invention, the transmitter and receiver are not limited thereto.

In feedback antenna port configuration operation, an antenna port serving as a reference of phase information may be fixed or variable per certain resource unit.

Here, the certain resource unit may be a time resource unit (e.g., a radio frame, subframe, slot, or OFDM symbol), a frequency resource unit (e.g., a resource block group (RBG), RB, or subcarrier), or a time-frequency resource unit. Although the certain resource unit is described as a transmission frame (or a frame) below for convenience of explanation and for brevity, this term should be understood as a certain time and/or frequency resource unit.

In channel information acquisition operation, the UE may report phase information per feedback antenna port periodically (e.g., a certain number of times) or aperiodically (e.g., based on triggering of the eNB), and the eNB may acquire CSI including the phase information. The channel information acquisition operation includes an operation for determining final phase information by accumulating phase information reported by the UE and calculating a weighted average thereof by the eNB.

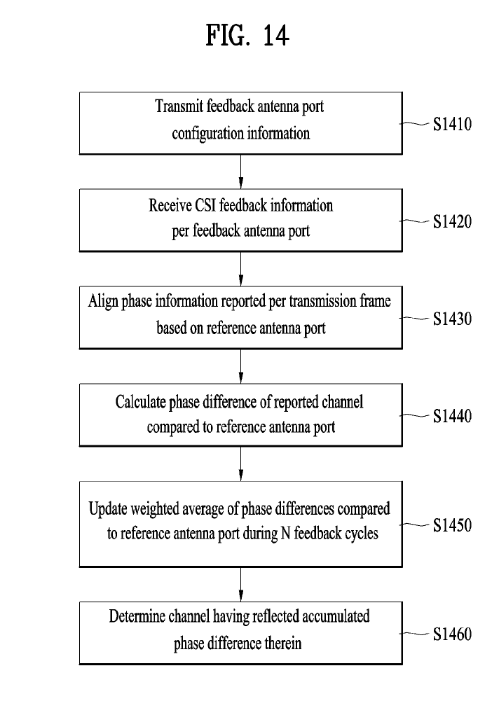

FIGS. 13 and 14 are flowcharts for describing CSI feedback operation according to the present invention.

In FIG. 13, the eNB may configure feedback antenna ports for receiving feedback information (or phase information) and signal information about the configured feedback antenna ports to the UE (S1310). The UE may generate and report CSI feedback information per feedback antenna port to the eNB based on the signaled information, and the eNB may receive the feedback information (S1320). The eNB may determine or calculate a phase difference of the reported channel compared to a reference antenna port (or based on the reference antenna port) (S1330). The eNB may update the phase difference by determining a weighted average of phase differences compared to the reference antenna port during a plurality of (e.g., N) feedback cycles (S1340). The eNB may determine a channel having reflected the accumulated phase difference therein (S1350).

FIG. 13 illustrates a case in which a reference antenna port (i.e., an antenna port serving as a reference of phase information) is fixed, and FIG. 14 illustrates a case in which the reference antenna port is variable per transmission frame. The embodiment of FIG. 14 is characterized in that a phase alignment step (S1430) is added compared to the embodiment of FIG. 13. Steps S1410 and S1420 of FIG. 14 correspond to S1310 and S1320 of FIG. 13, steps S1440 to S1460 of FIG. 14 correspond to steps S1330 to S1350 of FIG. 13, and thus repeated descriptions thereof are omitted herein.

Although the exemplary method of FIG. 13 or FIG. 14 is described as a series of steps for brevity, the above description does not limit the order of those steps and some or all of the steps may be performed simultaneously or in different orders as necessary. In addition, not all steps of FIG. 13 or FIG. 14 are inevitably necessary to implement the method proposed by the present invention.

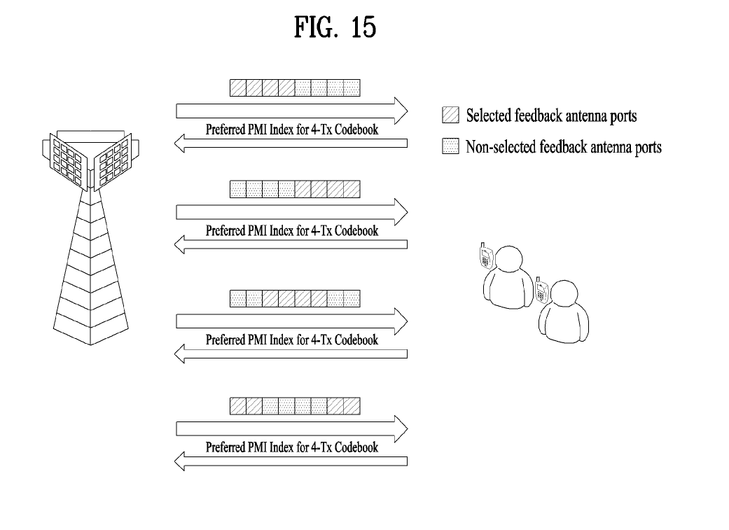

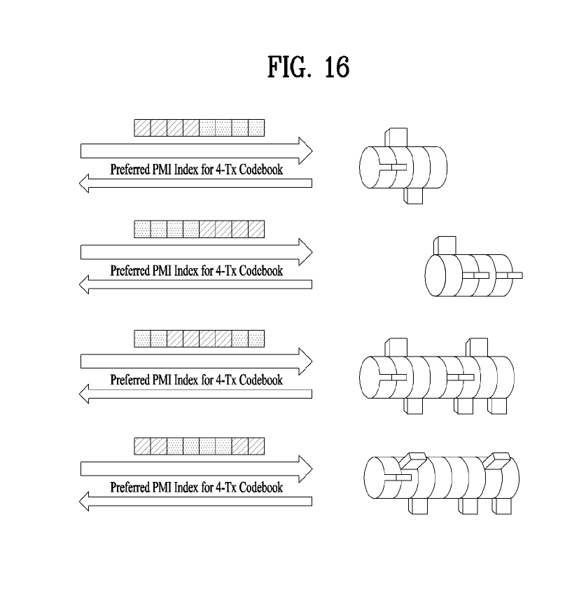

FIG. 15 is a view for describing a repeated CSI feedback method according to the present invention, and FIG. 16 is a view conceptually showing phase information per antenna port which is reported in each transmission frame.

In the present invention, the repeated CSI feedback method means that total CSI is divided into a plurality of fragments and the fragments are fed back and reported in different transmission frames. That is, the repeated CSI feedback method of the present invention is characterized in that total CSI is reported by repeating (or accumulating) feedback of a CSI fragment. The CSI fragments may be different pieces of CSI feedback information, but do not exclude the same piece of CSI feedback information. In addition, a part of any CSI fragment may overlap with a part of another CSI fragment.

FIG. 15 assumes that the eNB includes a total of 8 antenna ports and configures (or sets or allocates) 4 feedback antenna ports for each transmission frame. The total number of antenna ports of the eNB may be restricted by the number of physical antennas of the eNB.

In the first transmission frame, the UE may report phase information based on channel states measured for the first 4 antenna ports (e.g., antenna port indexes 0, 1, 2 and 3) selected from among the 8 antenna ports (e.g., antenna port indexes 0, 1, 2, 3, 4, 5, 6 and 7) of the eNB.

In the second transmission frame, the UE may report phase information based on channel states measured for the last 4 antenna ports (e.g., antenna port indexes 4, 5, 6 and 7) selected from among the 8 antenna ports of the eNB.

In the third transmission frame, the UE may report phase information based on channel states measured for the middle 4 antenna ports (e.g., antenna port indexes 2, 3, 4 and 5) selected from among the 8 antenna ports of the eNB.

In the fourth transmission frame, the UE may report phase information based on channel states measured for the first and last 4 antenna ports (e.g., antenna port indexes 0, 1, 6 and 7) selected from among the 8 antenna ports of the eNB.

If the antenna port index starts from 1, the antenna port indexes 0, 1, 2, 3, 4, 5, 6 and 7 in the above description according to the present invention may be replaced with antenna port indexes 1, 2, 3, 4, 5, 6, 7 and 8. These antenna port indexes are merely exemplary and should be understood as indexes for distinguishing between different antenna ports.

The UE may repeat the same operation during a cycle of transmission frames according to the above antenna port configuration. In addition, the phase information reported in each transmission frame may correspond to an index (i.e., PMI) indicating a precoding matrix preferred by the UE within a codebook designed for 4 Tx antennas (4Tx).

A detailed description is now given of a method for configuring feedback antenna ports, a method for acquiring channel information through repeated feedback, and a method for configuring and feeding back phase information having a high resolution based on a codebook having a restricted resolution, which are proposed by the present invention.

Feedback Antenna Port Configuration

The present invention proposes a method for configuring a number of feedback antenna ports less than the number of antenna ports of the eNB to prevent an increase in feedback overhead in CSI feedback supporting an increased number of antenna ports.

The following description assumes that, when a total number of antenna ports is M, K feedback antenna ports are configured every transmission frame, and N transmission frames are configured as one CSI feedback cycle.

As described above, a method using a fixed reference antenna port and a method for varying a reference antenna port per transmission frame may be used to configure feedback antenna ports.

For example, if the UE feeds back and reports phase information of antenna ports 1 to K among the total of M antenna ports in an N-th transmission frame, a set of the phase information may be denoted by Θ^{(N)} and expressed as Θ^{(N)}={θ₁^{(N)}, θ₂^{(N)}, . . . , θ_{K}^{(N)}}. Here, θᵢ^{(N)} denotes phase information of an antenna port index i in the N-th transmission frame.

If one fixed reference antenna port is configured, one specific antenna port is always included in the K antenna ports in all transmission frames. For example, if antenna port 1 among the total of M antenna ports is configured as the reference antenna port and K=2, phase information fed back in each transmission frame may be configured as Θ⁽¹⁾={θ₁⁽¹⁾, θ₂⁽¹⁾}, Θ⁽²⁾={θ₁⁽²⁾, θ₃⁽²⁾}, Θ⁽³⁾={θ₁⁽³⁾, θ₄^{(3)}, . . . .}

If a reference antenna port varies, phase information of a specific antenna port does not need to be fed back every transmission frame. For example, a part of feedback antenna ports of any transmission frame may overlap with a part of feedback antenna ports of another transmission frame. For example, Θ¹={θ₁⁽¹⁾, θ₂⁽¹⁾}, Θ⁽²⁾={θ₂⁽²⁾, θ₃⁽²⁾}, Θ⁽³⁾={θ₃⁽³⁾, θ₄⁽³⁾}, . . . may be configured. Alternatively, feedback antenna ports of all transmission frames may not overlap. For example, Θ¹={θ₁⁽¹⁾, θ₂⁽¹⁾}, Θ⁽²⁾={θ₃⁽²⁾, θ₄⁽²⁾}, . . . may be configured.

In this feedback antenna port configuration method, the CSI feedback cycle may be configured in such a manner that phase information of all antenna ports or phase information of partial antenna ports is fed back at least once.

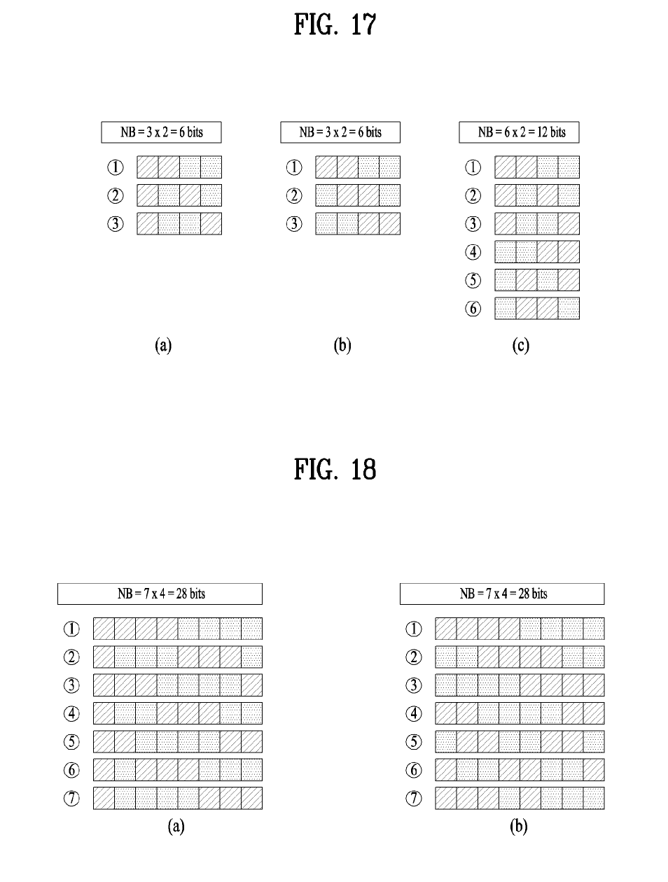

FIGS. 17 to 19 are views showing examples of the feedback antenna port configuration method according to the present invention.

FIG. 17 shows methods for feeding back phase information of 2 antenna ports in one transmission frame when a total number of antenna ports is 4. That is, this figure shows examples in the case of M=4 and K=2.

FIG. 17(a) is an example of a case when N=3 and a fixed reference antenna port is applied. For example, the one fixed reference antenna port may be antenna port index 0. In this case, phase information of antenna ports 0 and 1 may be fed back and reported in the first transmission frame, phase information of antenna ports 0 and 2 may be fed back and reported in the second transmission frame, and phase information of antenna ports 0 and 3 may be fed back and reported in the third transmission frame.

Furthermore, if it is assumed that feedback overhead for reporting a PMI for 2 antenna ports in one transmission frame in the example of FIG. 17(a) is 2 bits, feedback overhead of 6 bits may be generated during 3 transmission frames.

For example, it is assumed that a codebook corresponding to quantized phase information is used and a PMI indicating an optimal precoding matrix within a codebook is reported. For example, a codebook in the case of 2 antenna ports (i.e., rank-2 codebook) may perform feedback using 1, j, −1, and −j for a channel having the same phase, a channel having a phase difference of 0.5π radians, a channel having a phase difference of π radians, and a channel having a phase difference of 1.5π radians compared to the reference antenna port. In this case, it can be said that phase information having a resolution of 0.5π radians may be reported. This rank-2 codebook includes a total of 4 precoding matrix (or precoding vector) candidates, and 2 bits are required to indicate one of the 4 candidates. Although the above assumption is applied to the following examples to simply compare total sizes of feedback overhead, the scope of the present invention is not limited to the case in which actual PMI feedback overhead for 2 antenna ports is 2 bits.

FIG. 17(b) is an example of a case when N=3 and a reference antenna port is not fixed. For example, phase information of antenna ports 0 and 1 may be fed back and reported in the first transmission frame, phase information of antenna ports 1 and 2 may be fed back and reported in the second transmission frame, and phase information of antenna ports 2 and 3 may be fed back and reported in the third transmission frame. In the case of FIG. 17(b), feedback overhead of 6 bits may be generated during 3 transmission frames.

FIG. 17(c) shows a feedback antenna port configuration method in a case when N=6 and phase information of each antenna port is reported in 3 transmission frames. In this case, the phase information of each antenna port may be accumulated, and the eNB may use the same to determine final phase information of the corresponding antenna port. For example, phase information of antenna ports 0 and 1 may be fed back and reported in the first transmission frame, phase information of antenna ports 0 and 2 may be fed back and reported in the second transmission frame, phase information of antenna ports 0 and 3 may be fed back and reported in the third transmission frame, phase information of antenna ports 2 and 3 may be fed back and reported in the fourth transmission frame, phase information of antenna ports 1 and 3 may be fed back and reported in the fifth transmission frame, and phase information of antenna ports 1 and 2 may be fed back and reported in the sixth transmission frame. In the case of FIG. 17(c), feedback overhead of 12 bits may be generated during 6 transmission frames.

FIG. 18 shows methods for feeding back phase information of 4 antenna ports in one transmission frame when a total number of antenna ports is 8. That is, this figure shows examples in the case of M=8 and K=4.

FIG. 18(a) is an example of a case when N=7 and a fixed reference antenna port is applied. For example, the one fixed reference antenna port may be antenna port index 0. In this case, phase information of antenna ports 0, 1, 2 and 3 may be fed back and reported in the first transmission frame, phase information of antenna ports 0, 4, 5 and 6 may be fed back and reported in the second transmission frame, phase information of antenna ports 0, 1, 2 and 7 may be fed back and reported in the third transmission frame, phase information of antenna ports 0, 3, 4 and 5 may be fed back and reported in the fourth transmission frame, phase information of antenna ports 0, 1, 6 and 7 may be fed back and reported in the fifth transmission frame, phase information of antenna ports 0, 2, 3 and 4 may be fed back and reported in the sixth transmission frame, and phase information of antenna ports 0, 5, 6 and 7 may be fed back and reported in the seventh transmission frame. In the case of FIG. 18(a), feedback overhead of 28 bits may be generated during 7 transmission frames.

FIG. 18(b) is an example of a case when N=7 and a reference antenna port is not fixed. For example, phase information of antenna ports 0, 1, 2 and 3 may be fed back and reported in the first transmission frame, phase information of antenna ports 2, 3, 4 and 5 may be fed back and reported in the second transmission frame, phase information of antenna ports 4, 5, 6 and 7 may be fed back and reported in the third transmission frame, phase information of antenna ports 0, 1, 6 and 7 may be fed back and reported in the fourth transmission frame, phase information of antenna ports 1, 2, 5 and 6 may be fed back and reported in the fifth transmission frame, phase information of antenna ports 0, 3, 4 and 7 may be fed back and reported in the sixth transmission frame, and phase information of antenna ports 0, 1, 2 and 4 may be fed back and reported in the seventh transmission frame. In the case of FIG. 18(b), feedback overhead of 28 bits may be generated during 7 transmission frames.

In the case of FIG. 18(b), the phase information of antenna ports 0, 1, 2 and 4 may be accumulated in 4 transmission frames, and the phase information of antenna ports 3, 5, 6 and 7 may be accumulated in 3 transmission frames. The eNB may configure feedback antenna ports in such a manner that phase information of antenna ports, which require more precise phase information, is reported in a larger number of transmission frames compared to that of the other antenna ports, and signal information about the configured feedback antenna ports to the UE.

FIG. 19 shows a method for feeding back phase information of 4 antenna ports in one transmission frame when a total number of antenna ports is 16. That is, this figure shows an example in the case of M=16 and K=4.

FIG. 19 is an example of a case when N=5 and a fixed reference antenna port is applied. For example, the one fixed reference antenna port may be antenna port index 0. In this case, phase information of antenna ports 0, 1, 2 and 3 may be fed back and reported in the first transmission frame, phase information of antenna ports 0, 4, 5 and 6 may be fed back and reported in the second transmission frame, phase information of antenna ports 0, 7, 8 and 9 may be fed back and reported in the third transmission frame, phase information of antenna ports 0, 10, 11 and 12 may be fed back and reported in the fourth transmission frame, and phase information of antenna ports 0, 13, 14 and 15 may be fed back and reported in the fifth transmission frame. In the case of FIG. 19, feedback overhead of 20 bits may be generated during 5 transmission frames.

A description is now given of a method for signaling feedback antenna port configuration information from the eNB to the UE.

According to the 4^{th} wireless mobile communication standard, i.e., LTE-Advanced, CSI-RS used to acquire channel state information is defined as described below in 3GPP TS 36.213 v. 11.1.0 Section 7.2.5: “For a serving cell and UE configured in transmission mode 9 (TM9), the UE can be configured with one CSI-RS resource configuration. For a serving cell and UE configured in transmission mode 10 (TM10), the UE can be configured with one or more CSI-RS resource configuration(s). The following parameters are configured via higher layer signaling: a) CSI-RS resource configuration identity, if the UE is configured in TM10; b) Number of CSI-RS ports; c) CSI RS Configuration; and d) CSI RS subframe configuration.”

Here, parameter K (i.e., the number of antenna ports, phase information of which is to be transmitted in one transmission frame) defined in the present invention may be included in and transmitted together with the information about the number of CSI-RS ports.

Furthermore, parameter M (i.e., a total number of antenna ports), parameter N (i.e., the number of transmission frames for configuring one cycle according to feedback antenna port configuration) and/or information about a feedback antenna port configuration pattern defined in the present invention may be included in the CSI-RS resource configuration information.

In addition, various feedback antenna port configuration patterns (e.g., the examples of FIGS. 15 to 19) may be predefined or may be semi-statically configured or changed for the UE through higher layer signaling (e.g., RRC signaling).

That is, the feedback antenna port configuration information (e.g., parameters K, M, N, and/or pattern information) may be included in the existing CSI-RS resource configuration information and then transmitted to the UE. As such, when the UE calculates and reports feedback information per transmission frame, the UE may determine antenna ports, phase information of which should be calculated and reported.

Although step S1330 (i.e., operation for calculating the phase difference of the reported channel compared to the reference antenna port) of FIG. 13 or step S1430 (i.e., operation for aligning the phase information reported per transmission frame based on the reference antenna port) and step S1440 (i.e., operation for calculating the phase difference of the reported channel compared to the reference antenna port) of FIG. 14 are performed by the eNB in the above description, UE operation for assisting the calculation of the eNB may be configured.

For example, the UE may calculate optimal feedback information (specifically, phase information) on the assumption that the eNB performs operation such as phase alignment or phase difference calculation. That is, instead of simply calculating phase information per antenna port or selecting a PMI, an appropriate PMI may be selected in view of phase information of a corresponding antenna port among all antenna ports. Alternatively, the UE may directly perform phase alignment and/or phase difference calculation, and signal a resultant value thereof to the eNB. Otherwise, certain reference phase information may be predefined between the eNB and the UE, and the UE reports only a difference value from the reference phase information, thereby further reducing feedback overhead.

Although the above-described examples of the present invention are focused on a method for feeding back CSI of each antenna port in a case when the eNB includes multiple Tx antennas, the present invention also includes a similar method in a case when the UE includes 2 or more antennas. That is, when the UE includes multiple Rx antenna ports, a combination of a specific Tx antenna port and a specific Rx antenna port may be configured as a feedback antenna configuration pattern. For example, when the UE includes 2 Rx antenna ports, the UE may feed back and report phase information of the first Rx antenna port in the first N/2 transmission frames among N transmission frames, and feed back and report phase information of the second Rx antenna port in the last N/2 transmission frames. In addition, the UE may report control information indicating CSI feedback for multiple Rx antenna ports, to the eNB.

Furthermore, since Rx beamforming of the UE varies as a Tx antenna port of the eNB is changed, the eNB may not easily accurately predict CSI of all antenna ports even when CSI feedback information of specific antenna port(s) is accumulated. Accordingly, to accurately determine total CSI by accumulating CSI fragments, a method for fixing one Rx beam direction assumed to generate the CSI fragments may be applied.

Repeated Feedback Method

A description is now given of a method for acquiring channel information by repeatedly transmitting a transmission frame carrying CSI feedback by an MIMO transmitter.

According to the present invention, when codebook based channel phase information is acquired in a cellular mobile communication system, channel phase information of all antenna ports may be acquired by receiving feedback of channel phase information of some antenna ports separately through a plurality of transmission frames.

For example, when the number of antenna ports allocated to report phase information thereof in each transmission frame is less than a total number of antenna ports of the eNB as illustrated in FIG. 15, channel phase information fed back through a plurality of transmission frames may be acquired and used to determine final phase information to be used by the eNB. To this end, the eNB should acquire channel information through repeated feedback. For example, the eNB may accumulate phase information based on CSI fed back in transmission frames during N cycles, and determine an optimal precoding matrix based on the accumulated result.

In a system supporting an increased number of antenna ports compared to a legacy system, the number of antenna ports allocated to one transmission frame may be equal to or less than the maximum number of antenna ports defined for the legacy system. For example, a codebook for up to 8 Tx antenna ports may be designed for the legacy system, and a system supporting 16 Tx antenna ports may be configured to report CSI of 4 Tx antenna ports in one transmission frame. In this case, as phase information (or PMI) of antenna ports reported in one transmission frame, a PMI may be selected and reported using a codebook for 4 Tx antenna ports (i.e., rank-4 codebook) in the legacy system.

When channel phase information is fed back using a codebook of the legacy system as described above, since the transmission frame structure does not need to be changed or a new codebook does not need to be defined, an eNB (e.g., massive MIMO eNB) supporting an increased number of antenna ports may have backward compatibility to support operation of legacy users even when such eNB is newly installed.

Alternatively, a newly designed codebook may be used to appropriately support the increased number of antenna ports.

Furthermore, different codebooks may be predefined for transmission frames, or configuration information indicating a codebook to be used for each transmission frame may be provided to the UE through higher layer signaling (e.g., RRC signaling).

As such, the UE may determine a codebook to be applied or allocated to a specific transmission frame, and select and report a PMI corresponding to phase information that best reflects a current channel state in the corresponding codebook.

Final Phase Information Determination

A description is now given of a method for generating phase information (hereinafter referred to as a code vector) to be used for Tx beamforming by processing acquired channel information (specifically, phase information) of each antenna port by the eNB having received feedback of the channel information according to the above-described feedback antenna port configuration method and the repeated feedback method. The method for acquiring phase information based on CSI fragments as described above may also be called a code vector extension method.

Although this code vector extension operation may be performed by the eNB as described above in relation to FIGS. 13 and 14, the present invention is not limited to thereto and the UE may directly perform or assist the code vector extension operation. For example, the UE may calculate or generate channel information to be fed back in each transmission frame on the assumption that the eNB applies a specific code vector extension scheme. Here, the code vector extension scheme of the eNB which is assumed by the UE may be configured or changed for the UE by the eNB through higher layer signaling.

The CSI feedback method proposed by the present invention assumes that the phase alignment operation (e.g., step S1430 of FIG. 14) and/or the phase difference calculation operation (e.g., step S1330 of FIG. 13 or step S1440 of FIG. 14) are directly performed or assisted by the UE. In this case, a codebook to be used to calculate feedback information may be configured on a transmission frame basis (or on a transmission frame group basis). As such, more optimized feedback may be performed per transmission frame (or per transmission frame group), and this method may be used for multi-level beamforming.

For example, in a CSI feedback cycle configured as N transmission frames, a first codebook to be used in n transmission frames and a second codebook to be used the other N-n transmission frames may be separately configured. The first codebook may be designed to have a relatively lower resolution compared to the second codebook (i.e., the second codebook may be designed to have a relatively higher resolution compared to the first codebook). A low resolution of a codebook may mean that beams to be formed by elements (i.e., precoding matrices or precoding vectors) of the codebook are coarse, and a high resolution of the codebook may mean that the beams are fine. As such, an optimal beam direction may be approximately determined based on the channel information fed back in the n transmission frames and then the optimal beam direction may be finally determined based on the channel information fed back in the other N-n transmission frames.

The method for determining an optimal beam direction using different-level codebooks as described above may be directly performed by the eNB or the UE. Alternatively, the UE may calculate or generate feedback information at least on the assumption that the eNB determines a beam direction in this manner.

Although 2-level beamforming and feedback largely including feedback in n transmission frames and feedback in N-n transmission frames has been described in the above example for brevity, the scope of the present invention is not limited thereto and includes a beamforming and feedback method using codebooks of 3 or more levels.

A description is now given of a method for determining optimal phase information (or beam direction) of all antenna ports based on phase information of antenna ports acquired through a plurality of transmission frames (e.g., accumulation and/or a weighted average thereof).

The following description will be given on the assumption that a reference antenna port is fixed per transmission frame when feedback antenna ports are configured. If the reference antenna port varies, phase alignment based on the reference antenna port should be additionally considered to determine a final code vector.

Referring back to FIG. 16, a description is now given of a method for configuring an extended code vector based on phase information of a specific feedback antenna port. It is assumed that the eNB includes a total of 8 antenna ports (e.g., antenna port indexes 1, 2, 3, 4, 5, 6, 7 and 8 if the antenna port index starts from 1), and 4 feedback antenna ports are allocated to each transmission frame. It is also assumed that a codebook used in each transmission frame has a resolution of 0.5π radians.

In this case, phase information of 4 antenna ports (e.g., antenna port indexes 1, 2, 3 and 4) is fed back in the first transmission frame, and phase information of the other 4 antenna ports (e.g., antenna port indexes 5, 6, 7 and 8) is fed back in the second transmission frame.

In this case, the phase information fed back in the first and second transmission frames (i.e., acquired by the eNB) is estimated based on different (or independent) reference antenna ports. For example, relative phases of antenna ports other than antenna port index 1 (i.e., antenna port indexes 2, 3 and 4) may be acquired based on antenna port index 1 in the first transmission frame, and relative phases of antenna ports other than antenna port index 5 (i.e., antenna port index 6, 7 and 8) may be acquired based on antenna port index 5 in the second transmission frame. However, since a relative phase of the reference antenna port in each transmission frame cannot be acquired, information thereof should be additionally fed back to determine an optimal beamforming direction by the eNB.

Accordingly, feedback antenna ports of the third transmission frame are preferably configured to overlap with a part of the antenna ports fed back in the first and second transmission frames. For example, phase information of antenna port indexes 3, 4, 5 and 6 may be fed back in the third transmission frame.

The eNB having received the phase information in the first to third transmission frames may perform phase alignment based on a specific reference antenna port (e.g., antenna port index 1) to form a code vector to be applied to all antenna ports. For example, in the example of FIG. 16, phase alignment may be performed on the phase information fed back in the third transmission frame, based on the phase of antenna port index 3 of the first transmission frame (i.e., a relative phase of antenna port index 3 based on antenna port index 1). This phase alignment operation may be expressed as given by the following equation.

\hat{Θ}_{aligned}⁽³⁾=f(θ₃⁽¹⁾,\hat{Θ}⁽³⁾)={θ₃⁽¹⁾+θ₃⁽³⁾,θ₃⁽¹⁾+θ₄⁽³⁾,θ₃⁽¹⁾+θ₅⁽³⁾,θ₃⁽¹⁾+θ₆⁽³⁾} [Equation 8]

In Equation 8, \hat{Θ}_{aligned}^{(N)} denotes a result of phase alignment performed on phase information fed back in an N-th transmission frame. In addition, f(θᵢ^{(N}^{₁}⁾, \hat{Θ}^{(N}^{₂}⁾) denotes a function of an operation for performing phase alignment on a phase information set (i.e., \hat{Θ}^{(N}^{₂}⁾) fed back in an N₁-th transmission frame based on a phase value (i.e., θᵢ^{(N}^{₁}⁾) of an antenna port index i in the N₁-th transmission frame.

Furthermore, phase alignment may be performed on the phase information fed back in the second transmission frame, based on the phase of antenna port index 5 of the third transmission frame. Here, the phase of antenna port index 5 of the third transmission frame is a relative phase based on antenna port index 3, and a relative phase of antenna port index 5 based on antenna port index 1 may be determined based on the above relationship (i.e., θ₃⁽¹⁾+θ₅⁽³⁾. This phase alignment operation may be expressed as given by the following equation.

\hat{Θ}_{aligned}⁽²⁾=f(θ₃⁽¹⁾+θ₅⁽³⁾,\hat{Θ}⁽²⁾)={θ₃⁽¹⁾+θ₅⁽³⁾θ₅⁽²⁾,θ₃⁽¹⁾+θ₅⁽³⁾+θ₆⁽²⁾,θ₃⁽¹⁾+θ₅⁽³⁾+θ₇⁽²⁾,θ₃⁽¹⁾+θ₅⁽³⁾+θ₈⁽²⁾} [Equation 9]

As described above, phase alignment on phase information fed back in each transmission frame has the same meaning as the direction of a vector generated based on a sum of different vectors having the same size.

Furthermore, according to the present invention, a restricted codebook resolution may be complemented using accumulation and/or a weighted average of feedback information. For example, although an originally designed codebook is restricted to a resolution of 0.5π radians, phase information having a higher resolution (e.g., a resolution of 0.25 π radians) may be determined using phase information acquired through repeated feedback according to the present invention.

For example, even when the eNB additionally acquires feedback in the fourth transmission frame of FIG. 16, phase information of new antenna ports other than already fed back antenna ports is not acquired. However, compared to a case in which feedback information of only the first to third transmission frames is considered, if a code vector is determined in further consideration of feedback information of the fourth transmission frame, phase information may be updated or precise phase information may be determined using a restricted codebook resolution.

Specifically, it is assumed that a phase information set determined using the phase information acquired in the first to third transmission frame is denoted by \hat{Θ}_{old}={θ₁, θ₂, . . . , θ₇, θ₈}. In this case, precise phase information may be acquired or the phase information may be updated in further consideration of (or by calculating a weighted average of) a phase information set of \hat{Θ}⁽⁴⁾={θ₁⁽⁴⁾, θ₂⁽⁴⁾, θ₇⁽⁴⁾, θ₈⁽⁴⁾} in the fourth transmission frame.

If a reference antenna port of the phase information fed back in the fourth transmission frame differs from that of the previous transmission frames, phase alignment may be additionally performed. In the example of FIG. 16, the reference antenna port of the fourth transmission frame is antenna port index 1 which is the same as the reference antenna port of a result calculated by accumulating (or performing phase alignment on) the phase information of the first to third transmission frames, and thus additional phase alignment is not necessary.

The weighted average operation according to the current embodiment may be expressed as given by \hat{Θ}_{new}=g(\hat{Θ}^{(N)}, \hat{Θ}_{old}). Here, \hat{Θ}_{new} denotes a new phase information set updated according to the weighted average. In addition, g (Θ^{(N)}, \hat{Θ}_{old}) denotes a function of an operation for updating an old phase information set (i.e., \hat{Θ}_{old}) using feedback information (i.e., \hat{Θ}^{(N)}) in the N-th transmission frame (or an operation for calculating a weighted average through accumulation). The phase information set updated as described above (or final phase information set) may be expressed as given by the following equation.

$${\hat{Θ}}_{new} = \{ \frac{{θ}_{1} + {θ}_{1}^{( 4 )}}{2} , \frac{{θ}_{2} + {θ}_{2}^{( 4 )}}{2} , {θ}_{3} , {θ}_{4} , {θ}_{5} , {θ}_{6} , \frac{{θ}_{7} + {θ}_{7}^{( 4 )}}{2} , \frac{{θ}_{8} + {θ}_{8}^{( 4 )}}{2} \} \qquad [ Equation 10 ]$$

As given by Equation 10, only old phase information (i.e., θ₁, θ₂, θ₇, θ₈) corresponding to antenna port indexes 1, 2, 7 and 8 is separately summed with phase information (i.e., θ₁⁽⁴⁾, θ₂⁽⁴⁾, θ₇⁽⁴⁾, θ₈⁽⁴⁾) fed back in the 4-th transmission frame and then is updated by calculating an average thereof.

FIG. 17(a) shows an exemplary feedback antenna port configuration pattern in the case of M=4, K=2, and N=3. In this example, transmission frames use the same reference antenna port and thus an additional phase alignment step is not performed. If phase information received through 3 transmission frames is accumulated, the phase information of a finally generated code vector may be expressed as given by \hat{Θ}={θ₁⁽¹⁾, θ₂⁽¹⁾, θ₃⁽²⁾, θ₄⁽³⁾}.

FIG. 17(b) shows another exemplary feedback antenna port configuration pattern in the case of M=4, K=2, and N=3, and a reference antenna port varies every transmission frame. Accordingly, phase alignment should be performed on phase information fed back in each transmission frame to generate a final code vector. For example, phase alignment such as f(θ₂⁽¹⁾, \hat{Θ}₂) may be performed in consideration of feedback information of the second transmission frame. If phase information received through 3 transmission frames is accumulated, the phase information of a finally generated code vector may be expressed as given by \hat{Θ}={θ₁⁽¹⁾, θ₂⁽¹⁾, θ₂⁽¹⁾+θ₃⁽²⁾, θ₂⁽¹⁾+θ₃⁽²⁾+θ₄⁽³⁾}.

FIG. 17(c) shows an exemplary feedback antenna port configuration pattern in the case of M=4, K=2, and N=6. In this example, feedback antenna ports are configured to generate a code vector by accumulating channel phase information of 3 antenna ports other than a reference antenna port (e.g., antenna port index 1). As such, the resolution of the code vector may be increased by calculating an average of the phase information per antenna port which is fed back through a plurality of transmission frames.

FIG. 18(a) shows an exemplary feedback antenna port configuration pattern in the case of M=8, K=4, and N=7. In this example, antenna port index 1 is configured as a reference antenna port, and 3 contiguous feedback antenna ports are allocated every transmission frame in a cyclic manner. As such, transmission frames use the same reference antenna port and thus an additional phase alignment step may not be performed, accumulation of phase information may be performed a total of 3 times on each of antenna ports other than the reference antenna, and the resolution and phase accuracy of a code vector may be increased using an average of the accumulated information.

FIG. 18(b) shows another exemplary feedback antenna port configuration pattern in the case of M=8, K=4, and N=7. In this example, when a final code vector is generated, phase alignment should be performed on feedback information acquired in each step to synchronize a reference antenna port. Accumulation of phase information may be performed 3 times on each of antenna ports during 7 transmission frames other than a transmission frame in which the corresponding antenna port serves as the reference antenna port.

FIG. 19 shows an exemplary feedback antenna port configuration pattern in the case of M=16, K=4, and N=5. In this example, antenna port index 1 is configured as a reference antenna port, and 3 contiguous feedback antenna ports are allocated every transmission frame in a cyclic manner.

One CSI feedback cycle may be configured according to the above-described embodiments of the present invention, and this cycle may be repeated equally or different patterns of feedback antenna ports may be configured every cycle to update a channel phase variation or to increase the resolution of a generated code vector. If the CSI feedback cycle according to the same feedback antenna port pattern is repeated, the number of times that phase information of antenna ports other than a reference antenna port is accumulated equals the number of times that the cycle is repeated.

### Multilayer Transmission

A description is now given of a method for applying a codebook extension scheme according to the present invention in a multilayer transmission environment.

A wireless mobile communication system such as LTE supports multilayer transmission (or multi-rank transmission) when the rank of a channel matrix generated between one or more Tx antennas and one or more Rx antennas exceeds 1. A transmitter should accurately acquire information about a channel matrix H for multilayer transmission and, when PMI reporting is performed for the above purpose, a different code (i.e., a precoding matrix or a precoding vector) should be reported per rank. If the UE reports a PMI for codebook extension always using a code of rank 1, the eNB may not acquire information about a channel matrix having a rank of 2 or above at a time.

To solve the above problem, a UE equipped with multiple antennas may use an Rx antenna selection scheme for PMI reporting. Specifically, the UE may select an Rx antenna for channel reporting, report a PMI for the selected Rx antenna during a specific feedback cycle, and then report a PMI for another Rx antenna during another feedback cycle.

For example, if singular value decomposition is performed on a channel matrix H as H=USV, the UE having two Rx antennas may configure U=[1; 0] or U=[0; 1] to select one Rx antenna.

That is, when the UE is equipped with multiple Rx antennas, the above methods proposed by the present invention may be performed per Rx antenna of the UE. To this end, the UE may feed back at least one piece of the following information to the eNB together with the above specific feedback report (or separately by a specific time unit/interval): a) an Rx antenna index of the UE; and b) information indicating one of candidate matrices specifically quantized from the matrix U obtained as a result of performing singular value decomposition on the channel matrix H as H=USV.

Here, as an exemplary method for indicating the matrix U, the candidate matrices specifically quantized from the matrix U may be expressed as U(1), U(2), . . . , U(Q) and the UE may configure information (or an index value) indicating one of U(1), U(2), . . . , U(Q) while these matrices are predefined or semi-statically configured for the UE through higher layer signaling (e.g., RRC signaling).

Furthermore, this Rx antenna index (or Rx beamforming information) may be fed back through joint encoding with another type of feedback information such as RI, PMI, CQI, or precoder type indicator (PTI).

### Performance Analysis

The effect of the above examples of the present invention may be analyzed using a result of computer simulation. The performance evaluation may be analyzed by checking average correlation power μ between a code vector generated after a series of feedback procedures are finished, and an actual channel. The average correlation power is an indicator for evaluating phase correspondence between the actual channel and the code vector and may be defined as μ=E{|hw|²} when a channel vector generated between the antenna of an eNB and a UE to be served is denoted by h, and a code vector to be used for beamforming is denoted by w.

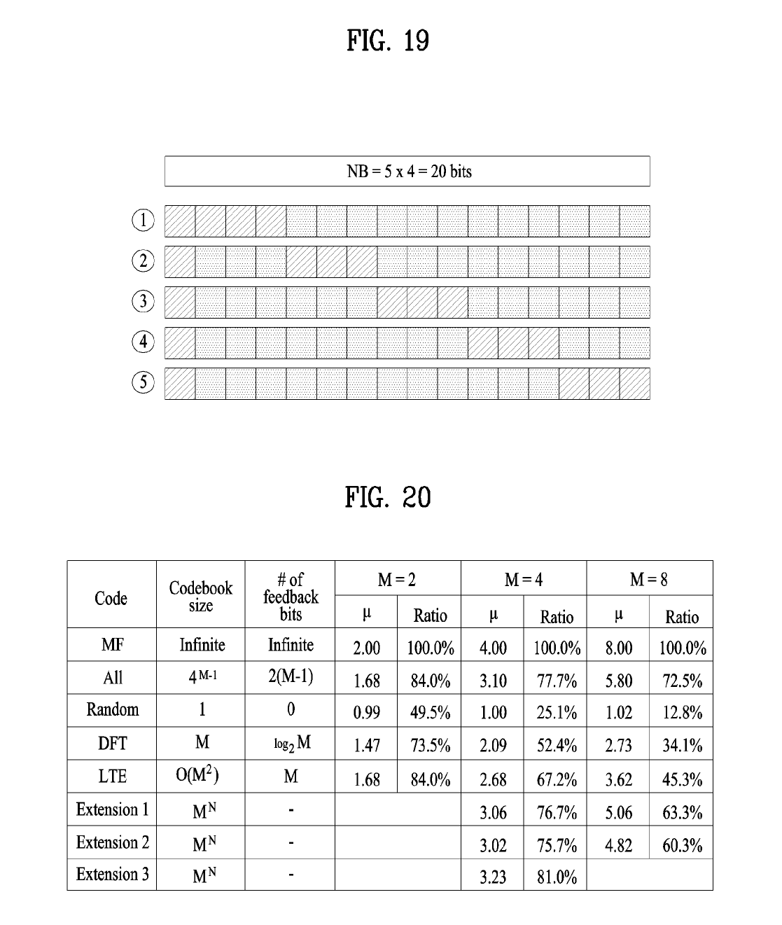

FIG. 20 is a table for comparing average correlation power of cases in which the schemes proposed by the present invention are applied, to that of cases in which legacy beamforming schemes are applied.

FIG. 20 shows ratios of the value μ compared to a matched filtering (MF) scheme for performing beamforming based on a Hermitian matrix of a channel matrix which is the theoretical upper limit. Among the legacy beamforming schemes, “All” refers to a scheme for performing PMI feedback by defining all combinations of elements of a code vector having a phase difference of 90 degrees, as a codebook. “Random” beamforming is defined as a case in which all elements of a code vector have a value of 1, and “DFT” uses a DFT matrix as a codebook. “LTE” assumes a case in which an LTE codebook of rank 1 is used.

In FIG. 20, Extension 1, Extension 2 and Extension 3 in a case when a total number of antennas is M=4 are simulation results according to the feedback antenna port configurations of FIGS. 17(a), 17(b) and 17(c), respectively. Furthermore, Extension 1 and Extension 2 in a case when a total number of antennas is M=8 are simulation results according to the feedback antenna port configurations of FIGS. 18(a) and 18(b), respectively.

As shown in FIG. 20, the CSI feedback methods according to the present invention have excellent channel correlation power compared to the case in which beamforming is performed using the codebook defined for the legacy LTE system. In addition, compared to the MF scheme which is the theoretical upper limit, the minimum channel correlation power of 60.3% is achieved when Extension 2 is used in the case of M=8 and the maximum channel correlation power of 81.0% is achieved when Extension 3 is used in the case of M=4.

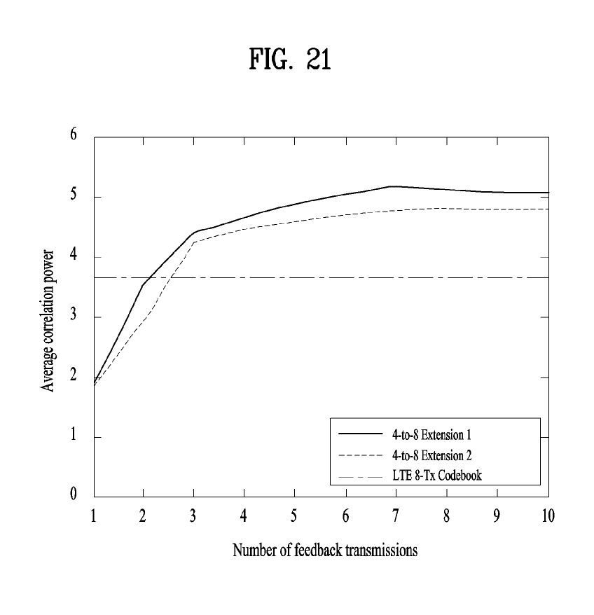

FIG. 21 shows a result of comparing average correlation power of cases in which the schemes proposed by the present invention are applied, to that of a case in which the 8Tx codebook of the LTE system is applied.

FIG. 21 is a graph for comparing average correlation power of transmission frames when a code vector is extended using the feedback antenna port configurations of FIGS. 18(a) and 18(b), to that of the legacy LTE 8-Tx codebook in a noise free channel in the case of M=8 and K=4. The average correlation power is superior to that of the LTE codebook after the third transmission frame.

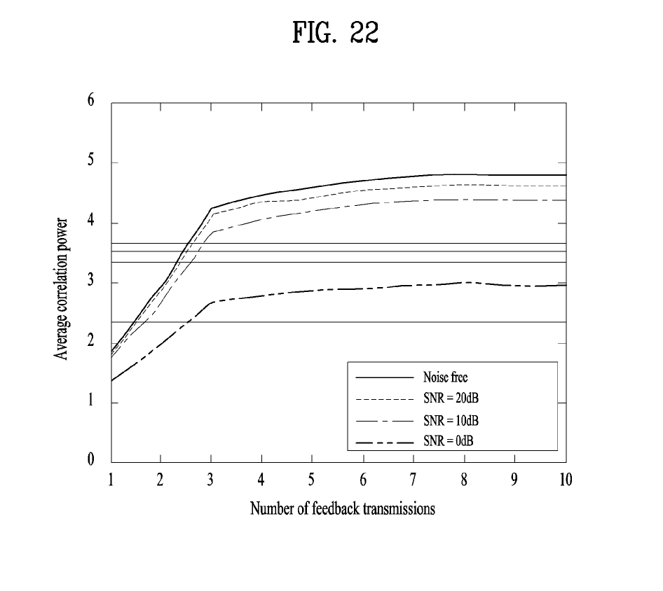

FIGS. 22 and 23 show results of comparing average correlation power of cases in which the schemes proposed by the present invention are applied, to that of a case in which the 8Tx codebook of the LTE system is applied, in a channel with noise.

FIG. 22 is a graph for comparing average correlation power of transmission frames when a code vector is extended using the feedback antenna port configuration of FIG. 18(a), to that of the legacy LTE 8-Tx codebook, and FIG. 23 is a graph for comparing average correlation power of transmission frames when a code vector is extended using the feedback antenna port configuration of FIG. 18(b), to that of the legacy LTE 8-Tx codebook. As shown in FIGS. 22 and 23, even when noise is added, the average correlation power is superior to that of the LTE codebook after the third transmission frame.

FIG. 23 is a graph showing average correlation power in a case when the feedback method according to the present invention is applied, in an environment where a total number of antennas of the eNB is 16.

FIG. 23 shows a simulation result according to the feedback antenna port configuration of FIG. 19, and is a graph showing average correlation power according to transmission frames. Excellent performance is achieved from the fifth frame in which phase information of all antenna ports is acquired in a noise free channel.

As described above, in the extension scheme according to the present invention, a new codebook does not need to be defined by using an LTE 4-Tx codebook in a PMI feedback procedure and extending the same through repeated feedback, and CSI feedback of excellent performance may be performed in an environment equipped with 16 antennas without increasing feedback antenna ports (or without increasing feedback overhead in one transmission frame).

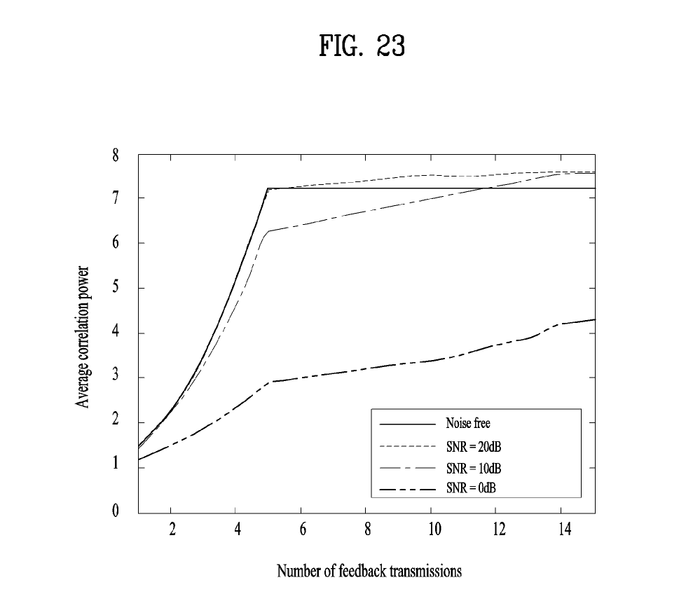

FIG. 24 is a view for describing an environment for testing a user transfer rate and a signal-to-interference-plus-noise ratio (SINR).

FIG. 24 assumes an environment where one interfering eNB and one service eNB are spaced apart from each other by a distance of 500 m and 4 UEs are located at the same position. The SINR may be defined as given by SINRₖ=|hₖwₖ|²/(Σ_{i≠k}|hₖwᵢ|²) for a k-th UE, and the user transfer rate is defined as given by Tₖ[n]=(1−t_{c}⁻¹) Tₖ[n−1]+t_{c}⁻¹ Rₖ[n] based on an instant transfer rate Rₖ=log₂(1+SINRₖ) at this time. In this case, n denotes the index of a tested time slot and t_{c} denotes a window size of a moving average. The proposed scheme is compared in performance to “Perfect CSIT (ZF)” corresponding to a case in which transmission is performed by applying a zero forcing (ZF) scheme while channel information is perfectly known, and transmission using the LTE 8-Tx codebook by applying ZF and MF schemes.

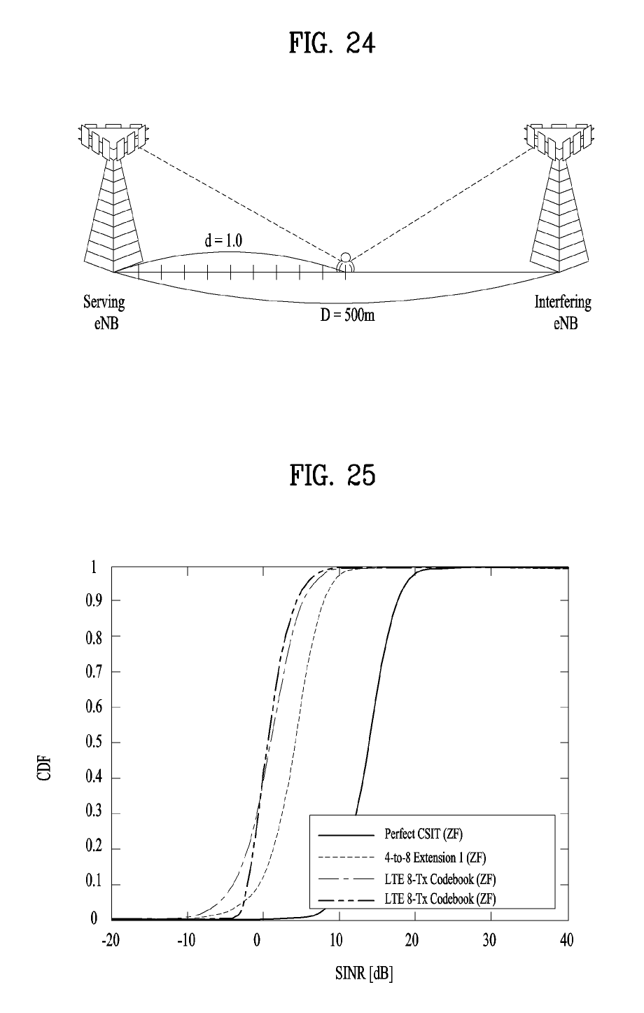

FIGS. 25 and 26 show a result of comparing the SINR and the user transfer rate in an environment where a total number of antenna ports of the eNB is 16.

Comparing the performance of a code vector generated after the feedback cycle of FIG. 17(a) is finished in the above example of the present invention, to that of the legacy schemes, the performance is superior to that of the legacy schemes using the LTE codebook in view of the SINR as shown in FIG. 25. In addition, the performance is improved by up to 2.62 bps/Hz compared to that of the legacy schemes using the LTE codebook as shown in FIG. 26.

The above-described proposal of the present invention is focused on CSI measurement based on CSI-RS, but may be equally or similarly extended and applied to CSI measurement and CSI feedback based on another reference signal (e.g., CRS, SRS, tracking RS (TRS), or DMRS) or another type of cell-specific or UE-specific reference signal.

The above-described embodiments of the present invention may be applied independently or in combination.

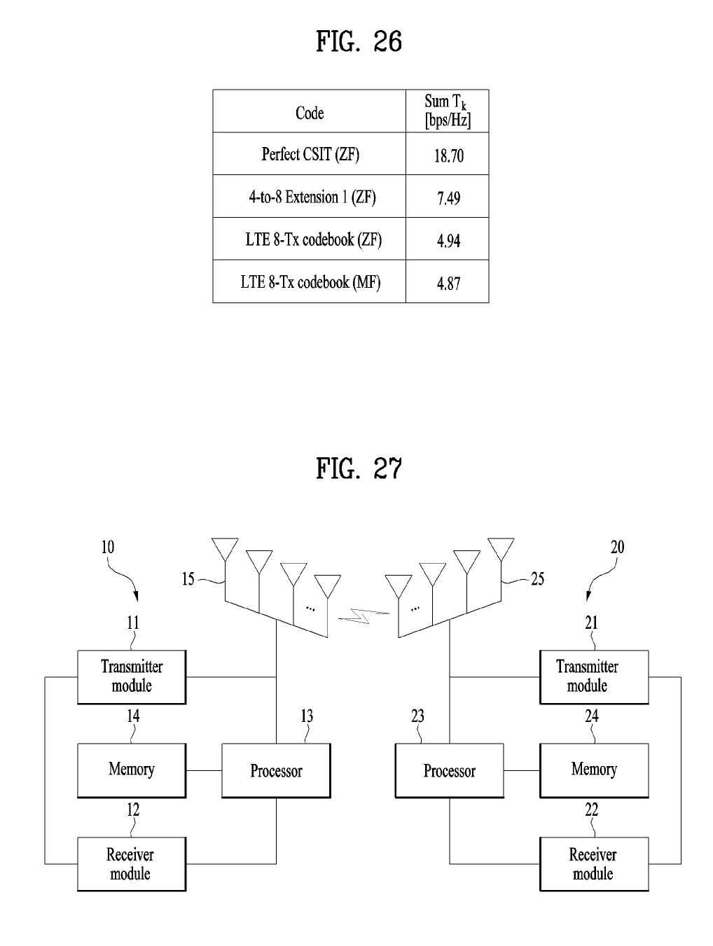

FIG. 27 is a block diagram of a UE 20 and a BS10 according to an embodiment of the present invention.

Referring to FIG. 27, the BS10 according to the present invention may include a transmitter module 11, a receiver module 12, a processor 13, a memory 14 and multiple antennas 15. The transmitter module 11 may transmit a variety of signals, data and information to an external device (e.g., UE). The receiver module 12 may receive a variety of signals, data and information from an external device (e.g., UE). The processor 13 may provide overall control to the BS10. The multiple antennas 15 may be configured based on, for example, a 2D antenna array.

The processor 13 of the BS10 according to an embodiment of the present invention may be configured to receive CSI based on the proposals of the present invention. Furthermore, the processor 13 of the BS10 may process information received and to be transmitted by the BS10, and the memory 14 may store the processed information for a predetermined time and is replaceable by another component such as a buffer (not shown).

Referring to FIG. 27, the UE 20 according to the present invention may include a transmitter module 21, a receiver module 22, a processor 23, a memory 24 and multiple antennas 25. The multiple antennas 25 refer to a device supporting MIMO transmission/reception. The transmitter module 21 may transmit a variety of signals, data and information to an external device (e.g., BS). The receiver module 22 may receive a variety of signals, data and information from an external device (e.g., BS). The processor 23 may provide overall control to the UE 20.

The processor 23 of the UE 20 according to an embodiment of the present invention may be configured to transmit CSI based on the proposals of the present invention. Furthermore, the processor 23 of the UE 20 may process information received and to be transmitted by the UE 20, and the memory 24 may store the processed information for a predetermined time and is replaceable by another component such as a buffer (not shown).

The above configuration of the UE 20 may be implemented in such a manner that the above-described embodiments of the present invention are applied independently or two or more embodiments are simultaneously applied thereto, and repeated descriptions thereof are not given here for clarity.

A BS is exemplified as a downlink transmission entity or an uplink reception entity and a UE is exemplified as a downlink reception entity or an uplink transmission entity to describe the embodiments of the present invention, but the scope of the present invention is not limited thereto. For example, the description of the BS may be equally applied to a case in which a cell, an antenna port, an antenna port group, a radio remote head (RRH), a transmission point, a reception point, an access point or a relay serves as an entity of downlink transmission to the UE or an entity of uplink reception from the UE.

In addition, the principle of the present invention described through various embodiments may be equally applied to a case in which a relay serves as an entity of downlink transmission to the UE or an entity of uplink reception from the UE or a case in which a relay serves as an entity of uplink transmission to the BS or an entity of downlink reception from the BS.

The above-described embodiments of the present invention may be implemented by various means, for example, hardware, firmware, software, or a combination thereof.

In a hardware configuration, the methods according to embodiments of the present invention may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the methods according to embodiments of the present invention may be implemented in the form of modules, procedures, functions, etc. for performing the above-described functions or operations. Software code may be stored in a memory unit and executed by a processor. The memory unit may be located inside or outside the processor and exchange data with the processor via various known means.

The detailed descriptions of the preferred embodiments of the present invention have been given to enable those skilled in the art to implement and practice the invention. Although the invention has been described with reference to the preferred embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

### INDUSTRIAL APPLICABILITY

Although a method for reporting channel state information (CSI) for 3-dimensional (3D) beamforming in a wireless communication system, and an apparatus therefor according to the present invention are applied to a 3GPP LTE system in the above description, the method and apparatus are also applicable to a variety of wireless communication systems other than the 3GPP LTE system.

1. A method for transmitting channel state information (CSI) by a user equipment (UE) in a wireless communication system, the method comprising:
receiving feedback antenna port configuration information from a base station (BS); and
transmitting CSI of K (K≧1) feedback antenna ports to the BS in each of N (N≧2) reporting resources,
wherein the K feedback antenna ports correspond to a part of M (M≧2) antenna ports,
wherein the CSI of the K feedback antenna ports comprises phase information of the K feedback antenna ports, and
wherein the phase information of the K feedback antenna ports is determined by assuming phase differences based on a reference antenna port.

2. The method according to claim 1, wherein the reference antenna port is configured equally in the N reporting resources.

3. The method according to claim 1, wherein, if the reference antenna port is configured differently in the N reporting resources, the phase information of the K feedback antenna ports is determined by assuming phase alignment based on the reference antenna port.

4. The method according to claim 1, wherein codebooks having different resolutions are applied to the N reporting resources or to reporting resource groups.

5. The method according to claim 1, wherein the N reporting resources comprise one or more pieces of CSI of each of the M antenna ports.

6. The method according to claim 1, wherein phase information of a specific antenna port among the M antenna ports is determined by assuming one or more of accumulation and a weighted average of phase information corresponding to the specific antenna port and transmitted in the N reporting resources.

7. The method according to claim 1, wherein the feedback antenna port configuration information comprises one or more of a value of N, a value of K, a value of M, and index information of the K feedback antenna ports allocated to each of the N reporting resources.

8. The method according to claim 1, wherein the K feedback antenna ports comprise one or more of antenna ports having different antenna port indexes in the N reporting resources.

9. The method according to claim 1, wherein the N reporting resources are configured as a combination of one or more time resources and one or more frequency resources.

10. The method according to claim 1, wherein the CSI further comprises receive (Rx) antenna port index information of the UE.

11. The method according to claim 1, wherein the CSI is reported periodically or aperiodically.

12. A method for receiving channel state information (CSI) by a base station (BS) in a wireless communication system, the method comprising:
transmitting feedback antenna port configuration information to a user equipment (UE); and
receiving CSI of K (K≧1) feedback antenna ports from the UE in each of N (N≧2) reporting resources,
wherein the K feedback antenna ports correspond to a part of M (M≧2) antenna ports,
wherein the CSI of the K feedback antenna ports comprises phase information of the K feedback antenna ports, and
wherein the phase information of the K feedback antenna ports is determined by assuming phase differences based on a reference antenna port.

13. A user equipment (UE) for transmitting channel state information (CSI) in a wireless communication system, the UE comprising:
a transmitter module;
a receiver module; and
a processor,
wherein the processor is configured to control the receiver module to receive feedback antenna port configuration information from a base station (BS), and control the transmitter module to transmit CSI of K (K≧1) feedback antenna ports to the BS in each of N (N≧2) reporting resources,
wherein the K feedback antenna ports correspond to a part of M (M≧2) antenna ports,
wherein the CSI of the K feedback antenna ports comprises phase information of the K feedback antenna ports, and
wherein the phase information of the K feedback antenna ports is determined by assuming phase differences based on a reference antenna port.

14. A base station (BS) for receiving channel state information (CSI) in a wireless communication system, the BS comprising:
a transmitter module;
a receiver module; and
a processor,
wherein the processor is configured to control the transmitter module to transmit feedback antenna port configuration information to a user equipment (UE), and control the receiver module to receive CSI of K (K≧1) feedback antenna ports from the UE in each of N (N≧2) reporting resources,
wherein the K feedback antenna ports correspond to a part of M (M≧2) antenna ports,
wherein the CSI of the K feedback antenna ports comprises phase information of the K feedback antenna ports, and
wherein the phase information of the K feedback antenna ports is determined by assuming phase differences based on a reference antenna port.
